(19) United States
(12) Patent Application Publication
(10) Pub. No.: US 2016/0210657 A1
(43) Pub. Date: Jul. 21, 2016

(54) REAL-TIME MARKETING CAMPAIGN STIMULI SELECTION BASED ON USER RESPONSE PREDICTIONS

(71) Applicants: Anto Chittilappilly, Waltham, MA (US); Payman Sadegh, Alpharetta, GA (US); Darius Jose, Thrissur (IN)

(72) Inventors: Anto Chittilappilly, Waltham, MA (US); Payman Sadegh, Alpharetta, GA (US); Darius Jose, Thrissur (IN)

(21) Appl. No.: 14/972,801

(22) Filed: Dec. 17, 2015

Related U.S. Application Data
(60) Provisional application No. 62/098,159, filed on Dec. 30, 2014.

(51) Int. Cl. G06Q 30/02; G06N 99/00

(52) U.S. Cl. CPC G06Q 30/0246; G06Q 30/0201; G06Q 30/0204; G06N 99/005

(57) ABSTRACT

A method, system, and computer program product for media spend management using real-time marketing campaign stimuli selection based on user response predictions. Embodiments commence upon identifying one or more users comprising an audience for one or more marketing campaigns. Observed touchpoint data records are collected based on audience responses to campaign stimuli. A collection of historical touchpoint data records are used to form a predictive model that captures relationships between the stimuli and the responses. At any moment in time, such as when a particular user is online, the predictive model is used to predict one or more next desired touchpoints based on a particular user's then-current online interactions. Marketing campaign stimuli that has a known historical effectiveness with respect to the desired touchpoints is reported. A marketing manager can increase the prevalence of such effective stimuli so as to increase the likelihood of desired responses by the particular user.

### RELATED APPLICATIONS

The present application claims the benefit of priority to co-pending U.S. Patent Application Ser. No. 62/098,159, entitled “REAPPORTIONING SPENDING IN AN ADVERTISING CAMPAIGN BASED ON A SEQUENCE OF USER INTERACTIONS” (Attorney Docket No. VISQ.P0015P), filed Dec. 30, 2014 which is hereby incorporated by reference in its entirety.

### FIELD OF THE INVENTION

The disclosure relates to the field of media spend management and more particularly to techniques for real-time marketing campaign stimuli selection based on user response predictions.

### BACKGROUND

An online user (e.g., prospect) in a given marketing campaign target audience can experience a high number of stimuli comprising exposures to a brand and product (e.g., touchpoints) across multiple digital media channels (e.g., display, paid search, paid social, etc.) and across multiple devices (e.g., desktop computer, tablet, mobile phone, etc.) on the journey to conversion (e.g., buying a product, etc.) and/or to some other engagement the Internet pertaining to the execution of the online marketing campaign can be used to determine the effectiveness of a particular stimulus (e.g., touchpoint) or combination of stimuli. For example, if a large percentage of online users who actually purchased the advertised product or service had made the purchase decision right after responding to some particular media stimulus, then a correlation between the response (e.g., purchase decision) and the stimulus can be made. A marketing manager for an advertiser and/or brand owner might want to know of such a correlation, and make advertising spending decisions based on some measure of the strength of the correlation. In some cases, a user can experience multiple media stimuli before executing the conversion event (e.g., making a purchase decision). In such cases, each of the stimuli can have a relative contribution to influencing the conversion event. The marketing manager might further want to know about all of such relative contributions in order to allocate spending to the various stimuli accordingly. In some cases, the contributions might indicate that the marketing manager should spend more on a particular stimulus in order to foster desired user experiences. In other cases, the contributions (or lack thereof) might indicate that the marketing manager should spend less or nothing on a particular stimulus.

Certain marketing campaign stimuli effectiveness measurement techniques, for example, can rely on reports of a number of stimuli (e.g., impressions, coupons, and associated user responses (e.g., conversions, non-conversions, etc.) from various media channels in a particular historical time period (e.g., previous week, previous month, etc.). The marketing manager can review the corresponding stimuli effectiveness results and make adjustments for the next deployment of the marketing campaign, or a deployment of an associated campaign, in a later time period. For example, the marketing manager might implement adjustments to a July campaign that increase the number of a certain call-to-action impression in the display channel based on the relatively high contribution of that impression measured for the month of May. In this case, the adjustments would pertain to the entire target audience for the campaign.

In other cases, an advertiser can use the stimuli effectiveness results to select certain stimuli to present to a particular user and/or pool of users in a retargeting campaign. Specifically, advertisers can track user online activity (e.g., cookies) to present selected stimuli (e.g., a retargeting ad) to users based on their activity. For example, the stimuli effectiveness results might indicate that delivering touchpointB to users who just experienced touchpointA might best move the users towards conversion. In such retargeting cases, the set of potential converting users is limited merely to users who experienced touchpointA. Also, the effectiveness of presenting touchpointB to such users can exhibit increasing uncertainty (e.g., degrading effectiveness) as time progresses from each user's touchpointA experience and/or the historical measurement period. The effectiveness of touchpointB can further exhibit variability as it pertains to each individual user. For example, a particular first user might have a pre-existing high propensity to convert such that spending on touchpointB for the first user would be unnecessary. As another example, a second user might have experienced touchpointA, but still have a low propensity to convert (e.g., as compared to the overall audience considered in the effectiveness measurement). In this case, for example, touchpointC might be more effective than touchpointB for the second user.

Techniques are therefore needed to address the problem of selecting the most effective mix of advertising stimuli to deliver to users. More specifically, techniques are needed to address the problem of real time selection of the most effective advertising stimuli to present to a particular user and/or pool of users.

None of the aforementioned legacy approaches achieve the capabilities of the herein-disclosed techniques for real-time marketing campaign stimuli selection based on user response predictions. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for real-time marketing campaign stimuli selection based on user response predictions.

Some embodiments commence upon identifying one or more users comprising an audience for one or more marketing campaigns. Observed touchpoint data records are collected based on audience responses to campaign stimuli. A collection of historical touchpoint data records are used to form a predictive model that captures relationships between the stimuli and the responses. At a later moment in time, the predictive model is used to predict one or more next desired touchpoints based on a particular user's then-current online interactions. Marketing campaign stimuli that has a known historical effectiveness with respect to the desired touchpoints is reported. A marketing manager can increase the prevalence of such effective stimuli so as to increase the likelihood of desired responses by the particular user.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A1 illustrates a scenario for real-time marketing campaign stimuli selection based on user response predictions, according to some embodiments.

FIG. 1A2 illustrates a real-time stimuli selection technique used in systems for real-time marketing campaign stimuli selection based on user response predictions, according to some embodiments.

FIG. 1B depicts techniques for real-time marketing campaign stimuli selection based on user response predictions, according to an embodiment.

FIG. 1C shows an environment in which embodiments of the present disclosure can operate.

FIG. 2A presents a touchpoint response predictive modeling technique used in systems for real-time marketing campaign stimuli selection based on user response predictions, according to some embodiments.

FIG. 2B presents a touchpoint attribute chart showing sample attributes associated with touchpoints of a marketing campaign, according to some embodiments.

FIG. 2C illustrates a touchpoint data record structure used in systems for real-time marketing campaign stimuli selection based on user response predictions, according to some embodiments.

FIG. 2D illustrates a user data record structure used in systems for real-time marketing campaign stimuli selection based on user response predictions, according to some embodiments.

FIG. 3A is a user interaction sequence progression chart depicting example user interaction sequences processed by systems for real-time marketing campaign stimuli selection based on user response predictions, according to an embodiment.

FIG. 3B is a user conversion propensity chart depicting example user conversion propensity stages processed by systems for real-time marketing campaign stimuli selection based on user response predictions, according to an embodiment.

FIG. 4 depicts a logical flow showing relationships among observations, events, and selection decision as implemented in systems for real-time marketing campaign stimuli selection based on user response predictions, according to some embodiments.

FIG. 5 presents a stimuli selection technique used in systems for real-time marketing campaign stimuli selection based on user response predictions, according to some embodiments.

FIG. 6A and FIG. 6B are a block diagrams of systems for real-time marketing campaign stimuli selection based on user response predictions, according to an embodiment.

FIG. 7A and FIG. 7B depict block diagrams of computer system components suitable for implementing embodiments of the present disclosure.

### DETAILED DESCRIPTION

The present application is related to co-pending U.S. patent application U.S. patent application Ser. No. 13/492,493 entitled “METHOD AND SYSTEM FOR DETERMINING A TOUCHPOINT ATTRIBUTION” (Attorney Docket No. VISQ.P0001), filed Jun. 8, 2012 which is hereby incorporated by reference in its entirety

### Overview

In a multi-channel marketing campaign, there may be many touchpoints (e.g., display ad, paid search results, etc.) that can serve as stimuli associated with an individual user. Such touchpoints can comprise a collection or “stack” of touchpoints that can each contribute in a portion to stimulate the user to take action. The last touchpoint in a series of touchpoints in a touchpoint stack (e.g., the “last click”) can be unambiguously correlated to a particular user conversion event (e.g., product purchase, whitepaper download, etc.). Further, using the techniques disclosed herein, the contribution of the other touchpoints in the touchpoint stack to moving the user to invoke the conversion event can be precisely (e.g., to a group or pool or segment of users) and unambiguously (e.g., to a calculable statistical certainty) determined.

Knowing individual users might have varying propensities to convert and/or transition to an incrementally higher propensity to convert, a marketing manager would want to predict if a particular user is likely to be positively responsive to certain stimuli that is intended and/or designed and/or placed in order to influence conversion, increase awareness, and/or achieve some other desired response. The marketing manager would want to predict with some degree of confidence whether or not a particular user is likely to be positively responsive to one or more stimuli intended to generate interest (e.g., brand awareness) and/or if a user is likely to be positively responsive to one or more stimuli intended to motivate the user to some action (e.g., conversion). If the marketing manager has a high confidence in a prediction that the user would respond positively to some particular stimulus, then the marketing manager would take steps to present such particular stimulus to that user. For example, the marketing manager might allocate a corresponding portion of the media spend budget for executing buys of the identified stimulus (e.g., impression). Conversely, if the marketing manager has a low confidence in a prediction that the user would respond positively to some particular stimulus (or a prediction that the user would respond negatively), then the marketing manager would take steps to avoid presenting such particular stimulus to that user so as to further avoid spending on the ineffective stimulus, improving the overall return on investment (ROT) of the media spend budget.

Certain marketing campaign stimuli effectiveness measurement techniques, for example, can determine stimuli effectiveness results associated with an audience of users for a given marketing campaign in a particular historical time period. Such stimuli effectiveness results can further be used by an advertiser to select certain stimuli to present to a particular user and/or pool of users in a retargeting campaign. Such retargeting techniques can be limited at least in the pool of users the retargeting stimuli can reach, and/or the effectiveness of the retargeting stimuli for the individual users in the retargeting pool.

Improvements discussed herein disclose techniques to select, in real time, the most effective mix of advertising stimuli to deliver to a user and/or group of users. Such selected stimuli is based on, and responsive to user interactions. More specifically, the selected stimuli is determined in real time by continually predicting a propensity score for each user based on the user's media consumption patterns. For example, delivering touchpointN to a first user whose media consumption produced a predicted propensity score of MM % might serve to move the first user towards conversion. As another example, delivering touchpointY to a second user whose media consumption produced a predicted propensity score of XX % might best move the second user towards conversion. The effectiveness touchpointN and touchpointD can be enhanced by selecting and serving the stimuli in real-time. The foregoing “pretargeting” approach can further determine user-specific stimuli for any user in the campaign audience (e.g., as compared to a subset of users in a retargeting approach).

Several prediction techniques are discussed herein. For example, prediction of a particular single user's propensity to respond to a certain mix of advertising stimuli based on a set of prior touchpoint interactions experienced by the user can suffer from a high error rate when the prediction is based on the limited information associated with just the single user. Yet, if predictions for a single ser are based on the actual observed behaviors of a group of users having the same or similar touchpoint interaction experiences, then the selection of advertising stimuli to present to a given user can be done with the confidence that at least a known percentage of users with the same characteristics will be responsive.

Strictly as one example, if a large percentage of online users are observed to have made purchase decisions after experiencing interactions with, for example, a touchpointA, followed by a touchpointB, and if only a small percentage of online users are observed to have made purchase decisions after experiencing interactions with, for example, touchpointA, followed by a touchpointC, then it would improve the effectiveness of the campaign to present touchpointB to a user in real time after that user had experienced touchpointA.

Other data characterizing various interactions can be observed, and the effectiveness of a particular interaction given a certain user propensity can be determined based on empirical measurements. As another example, if a certain set of online users are observed to have had a maximum increase in user propensity after experiencing interactions that produced a propensity score of 50%, followed by interactions with an advertisement in the form of “creativeB”, and if another set of online users are observed to have had a negligible increase in user propensity after experiencing interactions that also produced a propensity score of 50%, followed by interactions with “creativeC”, then it would improve the effectiveness of the campaign to present, in real time, to a user with a 50% propensity score, “creativeB” rather than “creativeC”.

Disclosed herein is a stimuli selection engine configured to receive user interaction data to generate a user propensity score for determining selected user stimuli to present to the user in real time. The user propensity score can be based on predicted responses derived from a touchpoint response predictive model formed from historical stimulus and response data. The selected user stimuli can be dynamically identified and delivered responsive to certain user interaction events. The selected user stimuli can further be based in part on a set of stimulus selection rules. In some cases, the stimulus selection rules and/or other parameters used by the stimuli selection engine can be received from a marketing management application used by a marketing manager.

### Definitions

Some of the terms used in this description are defined below for easy reference. The presented terms and their respective definitions are not rigidly restricted to these definitions a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

### Solutions Rooted in Technology

The appended figures corresponding discussion given herein provides sufficient disclosure to make and use systems, methods, and computer program products that address the aforementioned issues with legacy approaches. More specifically, the present disclosure provides a detailed description of techniques used in systems, methods, and in computer program products for real-time marketing campaign stimuli selection based on user response predictions. Certain embodiments are directed to technological solutions for detecting online user interactions to invoke a process for applying user interaction data to a response predictive model for determining a set of marketing stimuli to deliver to the user in real time, which embodiments advance the relevant technical fields, as well as advancing peripheral technical fields. The disclosed embodiments modify and improve over legacy approaches. In particular, the herein-disclosed techniques provide technical solutions that address the technical problems attendant to selecting the most effective mix of advertising stimuli to deliver to users responsive to one or more precipitating user interactions. Such technical solutions serve to reduce use of computer memory, reduce demand for computer processing power, and reduce communication overhead needed. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of high-performance computing as well as advances in various technical fields related to distributed storage.

Reference is now made in detail to certain embodiments. The disclosed embodiments are not intended to be limiting of the claims.

### DESCRIPTIONS OF EXEMPLARY EMBODIMENTS

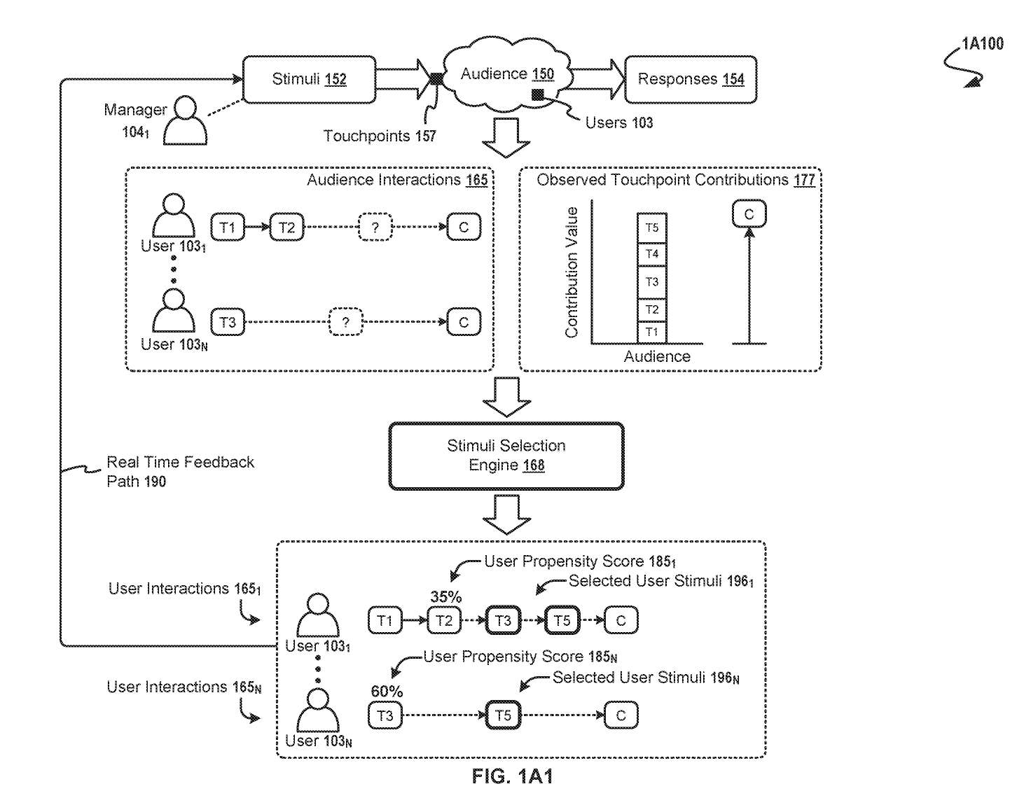

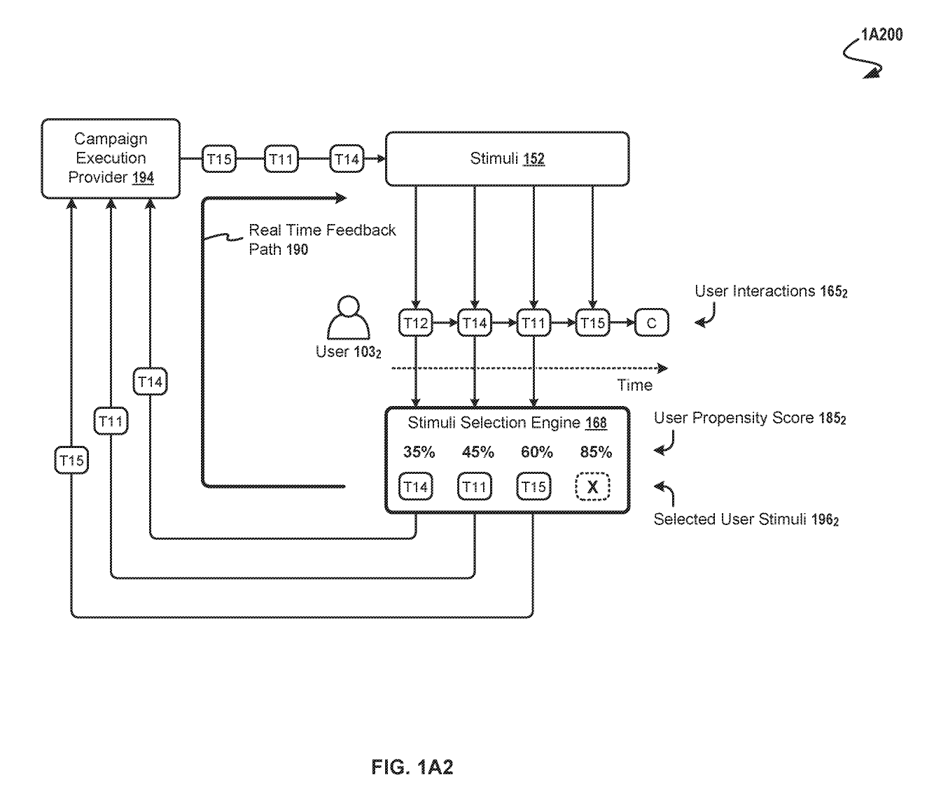

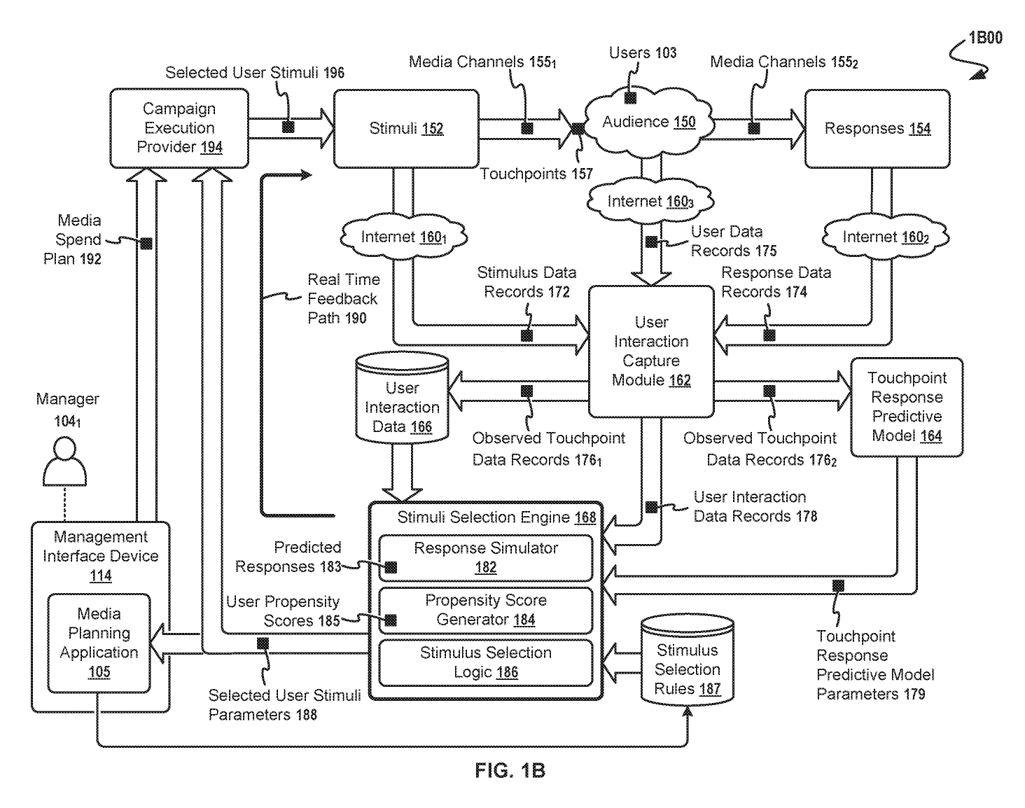

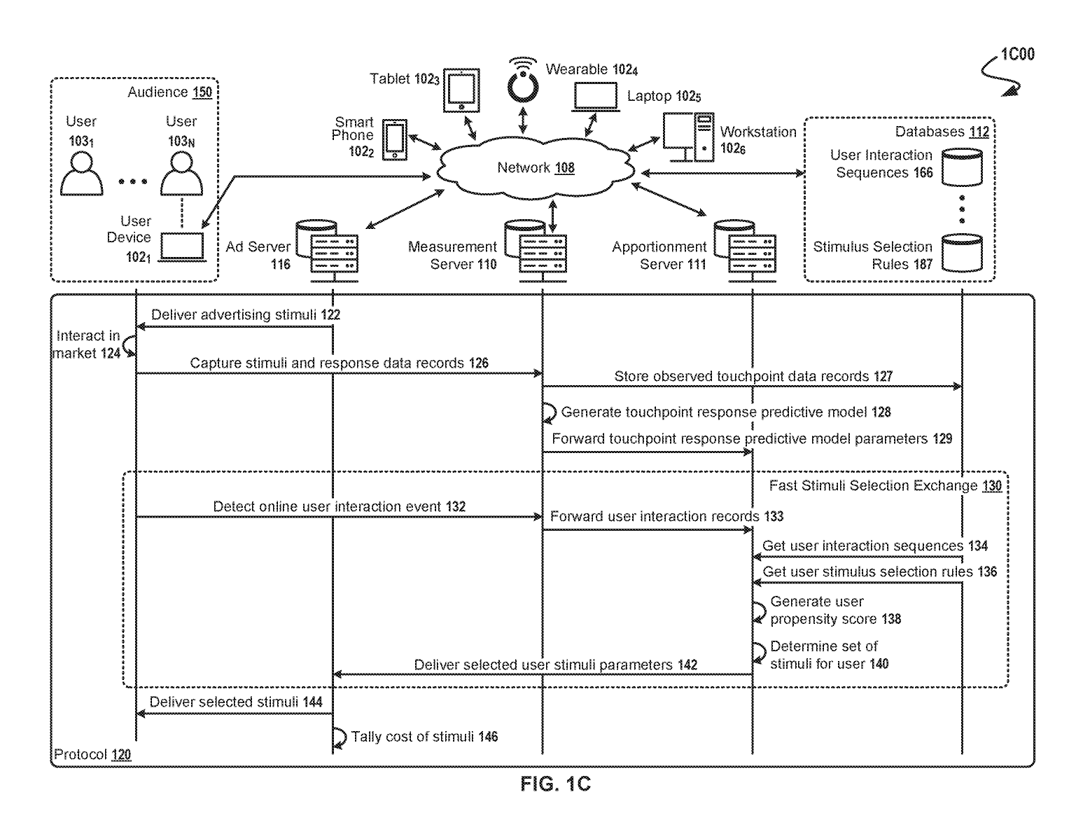

FIG. 1A1 illustrates a scenario 1A100 for real-time marketing campaign stimuli selection based on user response predictions. As an option, one or more instances of scenario 1A100 or any aspect thereof may be implemented in the context of the architecture and functionality of the embodiments described herein. Also, the scenario 1A100 or any aspect thereof may be implemented in any desired environment.

As shown in the scenario 1A100, a set of stimuli 152 is presented to an audience 150 of users 103 (e.g., as part of a marketing campaign), that further produces a set of responses 154. For example, the stimuli 152 might be part of a marketing campaign developed by a marketing manager (e.g., manager 104₁) to reach the audience 150 with the objective to generate user conversions (e.g., sales of a certain product). The audience 150 can be exposed to each stimulus comprising the stimuli 152 through a set of touchpoints 157 characterized by certain respective attributes. Data records corresponding to the audience interactions 165 pertaining to the stimuli 152, the responses 154, and/or other online events can be captured. The data records can further be used to determine a set of observed touchpoint contributions 177 characterizing the influence of certain instances of touchpoints 157 (e.g., T1, T2, T3, T4, T5, etc.) on leading the audience 150 to a conversion event C.

As shown, the audience interactions 165 might comprise certain touchpoints (e.g., T1, T2, T3, etc.) experienced by the particular shown users (e.g., user 103₁, . . . , to user 103_{N}) comprising the audience 150. In some cases, certain users might have traversed a sequence of touchpoints before executing the conversion event C. In other cases (e.g., for user 103₁ and user 103_{N}), certain users might not have converted. In such cases, the manager 104₁ might want to know what next set of stimuli should be presented to each user based on their current user propensity to most effectively influence the conversion of the user.

According to the herein disclosed techniques, a stimuli selection engine 168 can be used to address the problems attendant to selecting, in real time, the most effective next set of stimuli to deliver to user 103₁ and user 103_{N} based on each user's propensity to convert a given moment in time. Specifically, in one or more embodiments, the stimuli selection engine 168 can use the interactions of each subject user (e.g., user interactions 165₁ and user interactions 165_{N}), the observed touchpoint contributions 177, and/or other information to generate user propensity scores (e.g., user propensity score 185₁ and user propensity score 185_{N}, respectively) for determining selected user stimuli (e.g., selected user stimuli 196₁ and selected user stimuli 196_{N}, respectively) to deliver to each use (e.g., user 103₁ and user 103_{N}, respectively). For example, data records captured for user 103₁ might indicate the user has experienced touchpoint T1 and then touchpoint T2. Responsive to a certain interaction event from user 103₁ (e.g., touchpoint T2, app login, etc.), the stimuli selection engine 168 might determine the user 103₁ currently has a 35% propensity to convert. The stimuli selection engine 168 can use the foregoing information associated with user 103₁ to determine the selected user stimuli 196₁. Specifically, the touchpoint T3 followed by the touchpoint T5 might be identified as the most effective set of stimuli for influencing a conversion by user 103₁. As another example, data records captured for user 103_{N} might indicate the user has experienced touchpoint T3. Responsive to a certain interaction event from user 103_{N} (e.g., touchpoint T3, app login, etc.), the stimuli selection engine 168 can determine that the user propensity score 185_{N} for the user 103_{N} is 60%. The stimuli selection engine 168 might further identify the touchpoint T5 as the selected user stimuli 196_{N} most effective in influencing a conversion by user 103_{N}.

In one or more embodiments, parameters characterizing the selected user stimuli identified by the stimuli selection engine 168 can be transmitted through a real-time feedback path 190 to a campaign execution platform (e.g., demand side platform, ad server, etc.) to deliver the selected user stimuli to the corresponding users. Further details pertaining to such real-time stimuli selection and delivery facilitated by the herein disclosed techniques are described in FIG. 1A2.

FIG. 1A2 illustrates a real-time stimuli selection technique 1A200 used in systems for real-time marketing campaign stimuli selection based on user response predictions. As an option, one or more instances of real-time stimuli selection technique 1A200 or any aspect thereof may be implemented in the context of the architecture and functionality of the embodiments described herein. Also, the real-time stimuli selection technique 1A200 or any aspect thereof may be implemented in any desired environment.

As shown in FIG. 1A2, some embodiments of the herein disclosed techniques can form the real-time feedback path 190 that facilitates near immediate delivery of selected stimuli that can best (e.g., to a calculable statistical certainty) influence a maximum incremental increase in the user's then-current propensity to convert. Specifically, a user 103₂ might experience a touchpoint T12 from the stimuli 152 at a certain moment in time (see the user interactions 165₂). According to the herein disclosed techniques, the user interaction with touchpoint T12 can be detected by the stimuli selection engine 168 to calculate a propensity score for the user 103₂ (see 35% in the user propensity scores 185₂) that can be used to select one or more stimuli (see touchpoint T14 in the selected user stimuli 196₂) to present to the user 103₂. The selected touchpoint T14 can be transmitted to one or more entities such as a demand side platform, an ad server, an advertising network, etc. (e.g., see campaign execution provider 194) to deliver the selected user stimuli to the user 103₂. In some cases, the time lapse from the user interaction triggering the stimuli selection (e.g., the interaction with touchpoint T12) to the delivery of the selected stimuli to the user (e.g., delivery of touchpoint T14) is on the order of hundreds of milliseconds. The user 103₂ interaction with touchpoint T14 can further invoke the stimuli selection engine 168 to calculate a calculate a new propensity score for the user 103₂ (see 45% in the user propensity scores 185₂) that can be used to select one or more stimuli (see touchpoint T11 in the selected user stimuli 196₂) to present to the user 103₂. As shown, the earlier selected touchpoint T14 resulted in an incremental increase in user propensity of 10% (e.g., from 35% to 45%). The real-time feedback path 190 can further facilitate a later propensity score calculation (see 60% in the user propensity scores 185₂) following the interaction with touchpoint T11. When the user 103₂ interacts with touchpoint T15, the calculated propensity score (see 85% in the user propensity scores 185₂) indicates that no further stimuli is needed for the user 103₂ (e.g., the user 103₂ is “ready” to convert).

Further details relating to implementing the real-time stimuli selection technique 1A200 and/or other techniques disclosed herein for real-time marketing campaign stimuli selection based on user response predictions are described in FIG. 1B.

FIG. 1B depicts techniques 1B00 for real-time marketing campaign stimuli selection based on user response predictions. As an option, one or more instances of techniques 1B00 or any aspect thereof may be implemented in the context of the architecture and functionality of the embodiments described herein. Also, the techniques 1B00 or any aspect thereof may be implemented in any desired environment.

As shown in FIG. 1B and earlier described in FIG. 1A1, the set of stimuli 152 is presented to the audience 150 that further produces the set of responses 154. The stimuli 152 can be delivered to the audience 150 through certain instances of media channels 155₁ that can comprise digital or online media channels (e.g., online display, online search, paid social media, email, etc.). The media channels 155₁ can further comprise non-digital or offline media channels (e.g., TV, radio, print, etc.). The audience 150 is exposed to each stimulation comprising the stimuli 152 through the set of touchpoints 157 characterized by certain respective attributes. The responses 154 can also be delivered through other instances of media channels 155₂ that can further comprise online and offline media channels. In some cases, the information indicating a particular response can be included in the attribute data associated with the instance of the touchpoints 157 to which the user is responding.

As further shown, a set of stimulus data records 172 and a set of response data records 174 can be received over a network (e.g., Internet 160 and Internet 160₂, respectively) by a user interaction capture module 162. For example, the stimulus data records 172 and the response data records 174 can characterize attributes (e.g., time, channel, creative, campaign, etc.) corresponding to stimulus events and response events, respectively. The user interaction capture module 162 can further receive a set of user data records 175 over a network (e.g., Internet 160₃). For example, the user data records 175 can characterize user interaction events that may or may not be related to stimuli 152 and/or responses 154 (e.g., user login, user cookies, user activity logs, etc.). A set of user interaction data records 178 might be provided by the user interaction capture module 162 based on any of the stimulus data records 172, the response data records 174, and/or the user data records 175. For example, the user interaction data records 178 might indicate for a given user the most recent online interaction event (e.g., touchpoint interaction, website login, mobile app launch, geo-fence crossing, etc.).

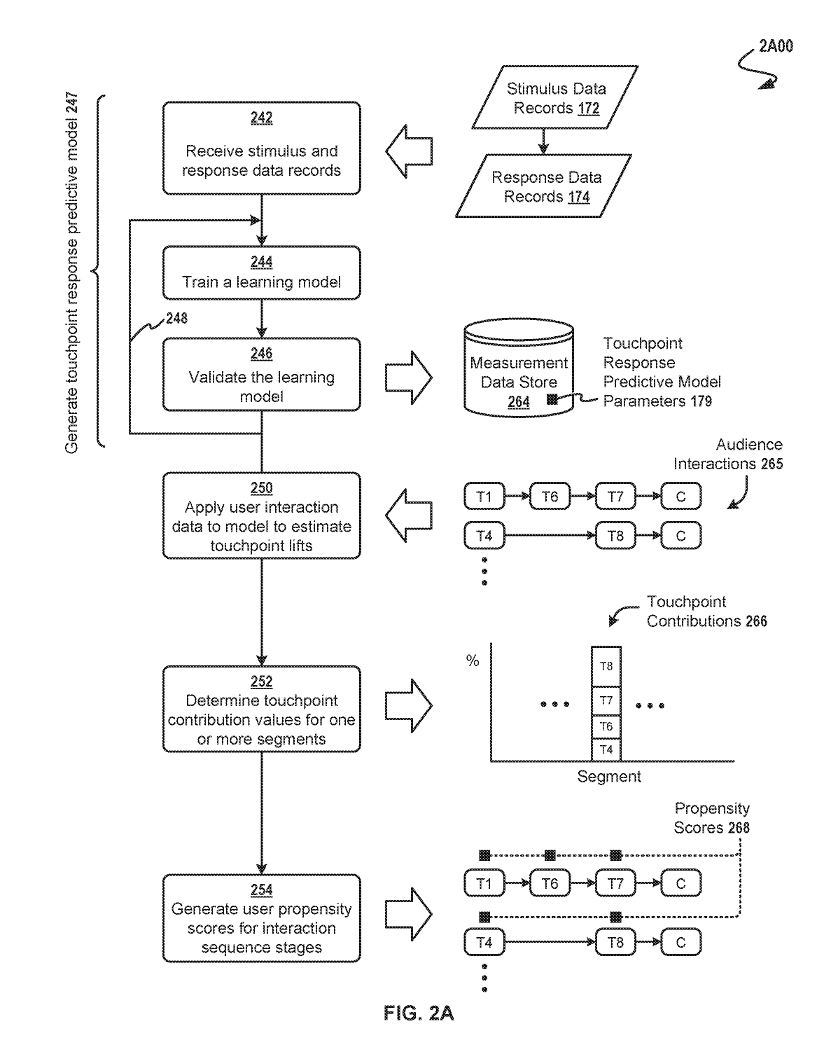

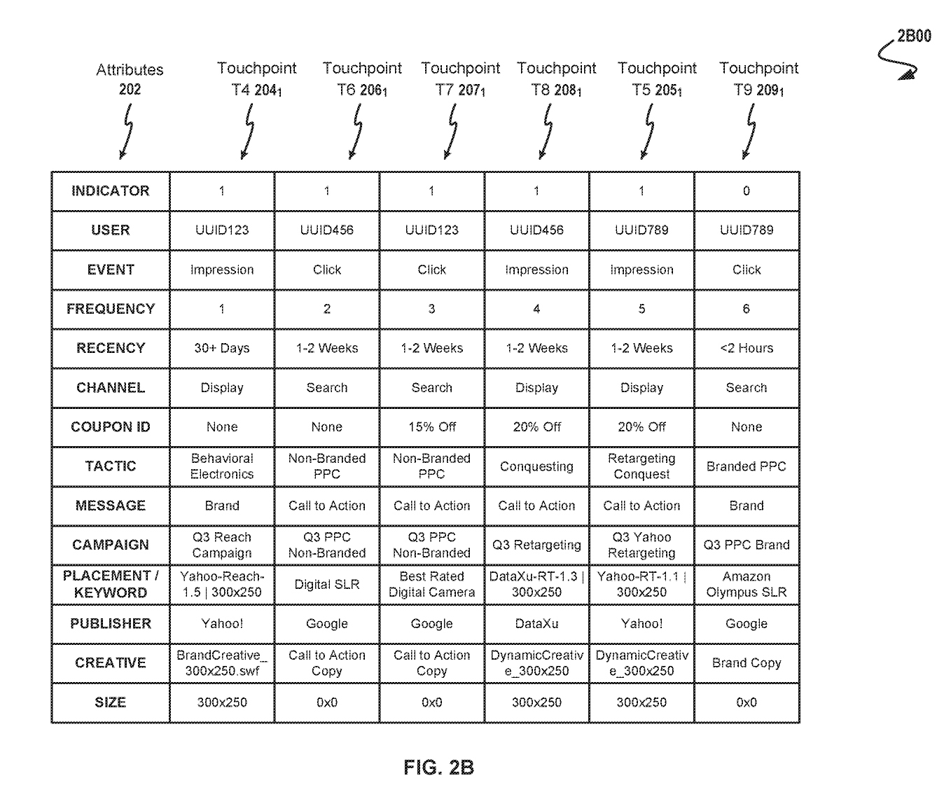

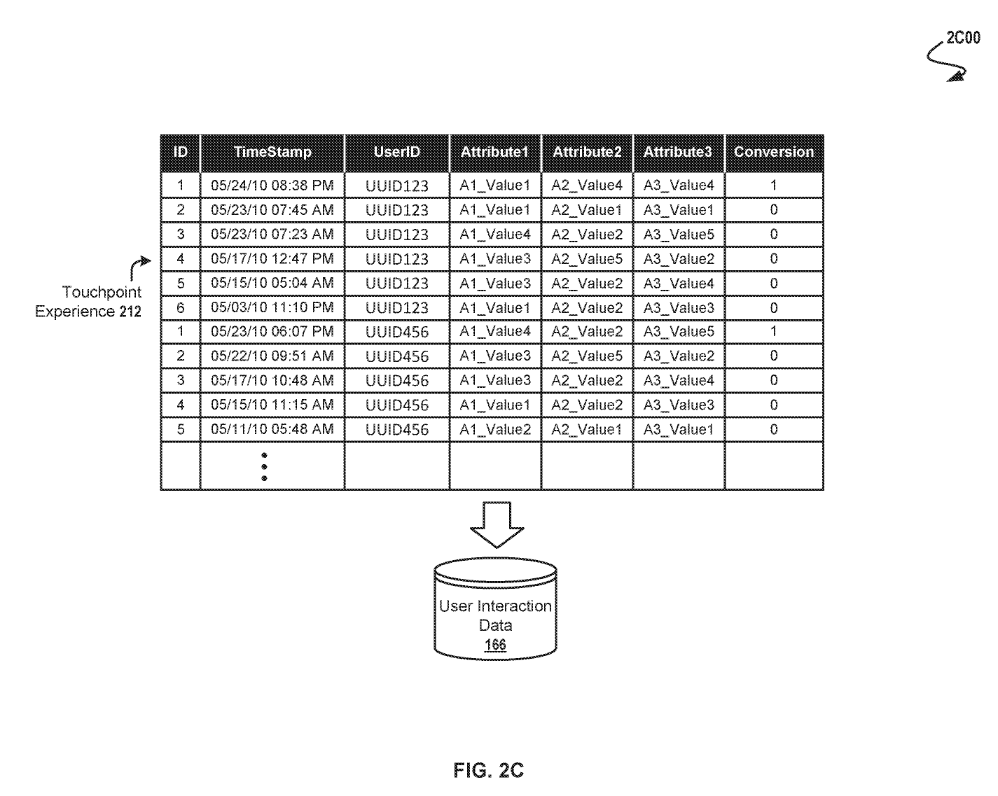

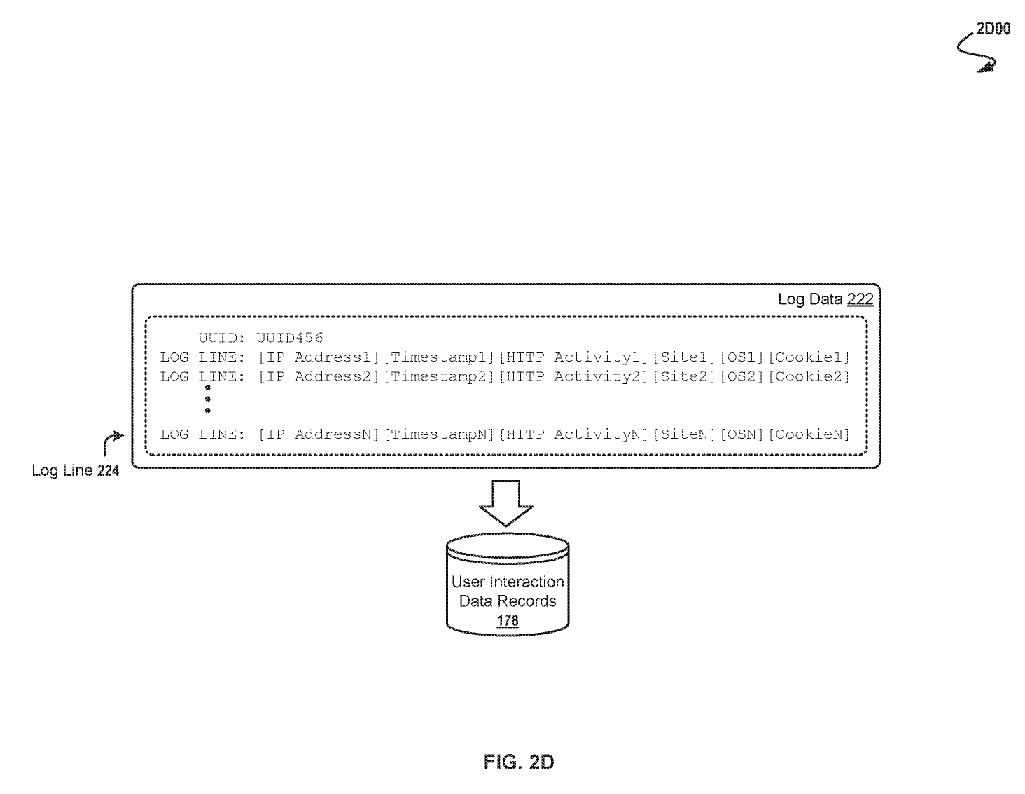

A set of observed touchpoint data records 176₁ derived from the stimulus data records 172. and/or the response data records 174 captured by the user interaction capture module 162 can be stored as instances of user interaction data 166. For example, such user interaction data 166 can comprise certain stimulus data records and/or response data records that have been be tagged and/or labeled such that a chronological sequence or progression or touchpoints for a particular user can be constructed from the corpus of captured data records. Further, a set of observed touchpoint data records 176₂ derived from the stimulus data records 172 and/or the response data records 174 captured by the user interaction capture module 162 can be used to generate a touchpoint response predictive model 164. The touchpoint response predictive model 164 can be used to estimate the effectiveness of each stimulus in a certain marketing campaign by attributing conversion credit (e.g., contribution value) to the various stimuli comprising the campaign. More specifically, touchpoint response predictive model 164 can be used to estimate the attribution (e.g., contribution value) of each stimulus and/or group of stimuli (e.g., a channel from the media channels 155₁) to the conversions comprising the response data records 174. The touchpoint response predictive model 164 can be formed using any machine learning techniques see FIG. 2A) to accurately model the relationship between the stimuli 152 and the responses 154. For example, weekly summaries of the stimulus data records 172 and the response data records 174 over a certain historical period (e.g., last six months) can be used to generate the touchpoint response predictive model 164. When formed, the touchpoint response predictive model 164 can be characterized in part by certain model parameters (e.g., input variables, output variables, equations, equation coefficients, mapping relationships, limits, constraints, etc.) comprising the touchpoint response predictive model parameters 179.

According to the herein disclosed techniques, the stimuli selection engine 168 can be used to address the problems attendant to selecting the most effective mix of advertising stimuli to deliver to one or more users responsive to one or more precipitating user interactions. Specifically, in one or more embodiments, the stimuli selection engine 168 can use the user interaction data 166, the touchpoint response predictive model parameters 179, the user interaction data records 178, and/or other information to generate user propensity scores (e.g., user propensity scores 185) for determining selected user stimuli (e.g., selected user stimuli 196) to deliver to respective users in audience 150. In some embodiments, an instance of the stimuli selection engine 168 can be used at the moment in time when a particular user is set to receive an impression. The stimuli selection engine 168 can then recommend one or more suggested next experiences to offer to a user based on that user's prior sequence of touchpoint experiences and/or that user's propensity score.

More specifically, in one or more embodiments, the stimuli selection engine 168 might comprise a response simulator 182, a propensity score generator 184, and a set of stimulus selection logic 186. In some cases, an instance of the user interaction data records 178 associated with a given user (e. ser touchpoint access) might invoke the response simulator 182 to apply the user interaction data corresponding to the user to the touchpoint response predictive model 164 (e.g., using the touchpoint response predictive model parameters 179) to generate a set of predicted responses 183. For example, the predicted responses 183 might indicate the expected user responses to various sets of selected stimuli based on the actual observed behaviors (e.g., from observed touchpoint data records 176₂) of a group of users (e.g., from audience 150) having the same or similar touchpoint interaction experiences. The propensity score generator 184 can use the predicted responses 183 and/or other information to generate a set of user propensity scores 185 for a respective set of stimuli. The stimulus selection logic 186 can use the user propensity scores 185 to determine the selected user stimuli 196. For example, the stimulus selection logic 186 might select the set of stimuli corresponding to the highest user propensity score from the net of user propensity scores 185. In some cases, a set of stimulus selection rules 187 can be used by the stimulus selection logic 186 to determine the selected user stimuli 196. For example, a certain stimulus selection rule might indicate that no stimuli are selected for users having a maximum user propensity score less than 20%. Another stimulus selection rule might indicate a lower cost set of stimuli associated with a lower user propensity score be selected over a high cost set of stimuli associated with a higher user propensity score.

In some embodiments, a set of selected user stimuli parameters 188 characterizing the selected user stimuli 196 can be transmitted to the campaign execution provider 194 to deliver the selected user stimuli 196 to the respective user. Such a data flow can comprise the real-time feedback path 190 that facilitates near immediate delivery of stimuli that can best (e.g., to a calculable statistical certainty) influence a maximum incremental increase in a particular user's then-current propensity to convert. In other cases, the selected user stimuli parameters 188 can be transmitted to a media planning application 105 operating on a management interface device 114 for presentation to the manager 104₁. For example, the media planning application 105 might use the selected user stimuli parameters 188 to present a visualization of the selected user stimuli 196 identified by the stimuli selection engine 168 according to the herein disclosed techniques. The manager 104₁ might then use such information to determine a media spend plan 192 that can be deployed to the campaign execution provider 194. As an example, the manager might use one or more of the user stimuli parameters to determine a spending decision (e.g., to increase spending pertaining to the particular stimuli) or, the marketing manager or real-time agent might use the user stimuli parameters to establish a bid amount to be spent on delivering an impression to a subject user.

The herein-disclosed technological solution described by the techniques 1B00 in FIG. 1B can be implemented in various network computing environments and associated online and offline marketplaces. Such an environment is discussed as pertains to FIG. 1C.

FIG. 1C shows an environment 1C00 in which embodiments of the present disclosure can operate. As an option, one or more instances of environment 1C00 or any aspect thereof may be implemented in the context of the architecture and functionality of the embodiments described herein. Also, the environment 1C00 or any aspect thereof may be implemented in any desired environment.

As shown in FIG. 1C, the environment 1C00 comprises various computing systems (e.g., servers and devices) interconnected by a network 108. The network 108 can comprise any combination of a wide area network (e.g., WAN), local area network (e.g., LAN), cellular network, wireless LAN (e.g., WLAN), or any such means for enabling communication of computing systems. The network 108 can also be referred to as the Internet. More specifically, environment 1C00 comprises at least one instance of a measurement server 110, at least one instance of an apportionment server 111, at least one instance of an ad server 116, and a set of databases 112 (e.g., user interaction data 166, stimulus selection rules 187, etc.). The servers and devices shown in environment 1C00 can represent any single computing system with dedicated hardware and software, multiple computing systems clustered together (e.g., a server farm, a host farm, etc.), a portion of shared resources on one or more computing systems (e.g., a virtual server), or any combination thereof. In one or more embodiments, the ad server 116 can represent an entity (e.g., campaign execution provider) in an online advertising ecosystem that might facilitate the delivery of selected user stimuli identified according to the herein disclosed techniques.

The environment 1C00 further comprises at least one instance of a user device 102₁ that can represent one of a variety of other computing devices (e.g., a smart phone 102₂, a tablet 102₃, a wearable 102₄, a laptop 102₅, a workstation 102₆, etc.) having software (e.g., a browser, mobile application, etc.) and hardware (e.g., a graphics processing unit, display, monitor, etc.) capable of processing and displaying information (e.g., web page, graphical user interface, etc.) on a display. The user device 102₁ can further communicate information (e.g., web page request, user activity, electronic files, computer files, etc.) over the network 108. The user device 102₁ can be operated by a user 103_{N}. Other users (e.g., user 103₁) with or without a corresponding user device can comprise the audience 150.

As shown, the user 103₁, the user device 102₁ (e.g., operated by user 103_{N}), the measurement server 110, the apportionment server 111, the ad server 116, and the databases 112 (e.g., operated by the manager 104₁) can exhibit a set of high-level interactions (e.g., operations, messages, etc.) in a protocol 120. Specifically, the protocol 120 can represent interactions in systems for real-time marketing campaign stimuli selection based on user response predictions. As shown, the ad server 116 can deliver advertising stimuli to the audience 150 through certain media channels according to one or more marketing campaigns (see message 122). The users in audience 150 can interact with the various advertising stimuli delivered (see operation 124), such as taking one or more measureable actions in response to such stimuli and/or other non-media effects. Information characterizing the stimuli and responses of the audience 150 can be captured as stimulus data records and response data records by the measurement server 110 (see message 126). All or a portion of the captured stimulus data records and/or response data records can be stored by the measurement server as observed touchpoint data records in one or more of the databases (see message 127). For example, certain sets of the observed touchpoint data records might be associated with respective users and stored as user interaction data 166. Using the stimulus and response data, the measurement server 110 can further form a touchpoint response predictive model (see operation 128). The touchpoint response predictive model, for example, can be used to predict the response of a particular user to various scenarios of presented stimuli given that user's prior sequence of touchpoint experiences. Certain parameters characterizing the touchpoint response predictive model can be availed to the apportionment server 111 to facilitate use of the model for various processes (see message 129).

As highlighted in the protocol 120, a grouping 130 can represent one embodiment of certain messages and operations used in systems and protocols for real-time marketing campaign stimuli selection based on user response predictions. Specifically, such a fast stimuli selection exchange might commence with certain online user interaction events being detected at the measurement server 110 (see message 132). For example, such user data interactions might indicate for a subject user the most recent online interaction event (e.g., touchpoint interaction, website login, mobile app launch, geo-fence crossing, etc.). One or more user interaction data records characterizing the user data interactions can be forwarded by the measurement server 110 to the apportionment server 111 to invoke certain message and/or operations responsive to the detected user interactions see message 133). Specifically, the apportionment server 111 can access the user interaction sequence associated with the subject user (see message 134). The apportionment server 111 can further get one or more user stimuli selection rules e.g., from stimulus selection rules 187) associated with the audience and/or marketing campaign comprising the subject user (see message 136). Using the foregoing information availed to the apportionment server 111, a user propensity score can he generated for the subject user (see operation 138). For example, the user interaction sequence for the subject user might be applied to the touchpoint response predictive model to simulate a set of predicted responses used to generate a user propensity score for the subject user. Such a user propensity score can indicate the subject user's propensity to convert given the subject user's touchpoint experiences up to that moment in time and/or certain further stimuli that might be presented to the subject user. In some cases, such user propensity scores might be held in a cookie score vector structure comprising at least a reference to one or more subject user cookies, a user propensity score, and/or an associated confidence score characterizing a confidence interval of the user propensity score calculation.

A set of stimuli (see operation 140) for the subject user can then be identified based on the user propensity score, the stimulus selection rules, and/or other information (e.g., stimulus selection logic, corpus of available campaign stimuli, etc.). For example, if the user propensity score is above a user propensity score threshold and/or if the confidence score is above a confidence score threshold (e.g., the thresholds specified in the stimulus selection rules), then the set of stimuli for the subject user can be selected. If the user propensity score and/or the confidence score do not meet certain criteria, stimuli for the subject user might not be selected (e.g., decision to not spend on the subject user). Parameters characterizing any selected user stimuli can be delivered by the apportionment server 111 to the ad server 116 (see message 142) to facilitate delivery of the stimuli to the subject user (see message 144). In some cases, the stimuli (e.g., impressions, etc.) can be tallied, and the cost of the stimuli can be added to the account of the advertiser (see operation 146).

In exemplary cases, the time duration between the detected user interaction (see message 132) and delivery of the selected user stimuli (see message 144) is on the order of hundreds of milliseconds. In some cases, a significant portion of the decision-making logic is hosted at the apportionment server 111 and/or the measurement server 110. In other cases, portions of the decision-making logic are distributed between the servers and devices shown in environment 1C00. The fast stimuli selection exchange is facilitated in part by the touchpoint response predictive model. More details pertaining such touchpoint response predictive models are discussed in the following and herein.

FIG. 2A presents a touchpoint response predictive modeling technique 2A00 used in systems for real-time marketing campaign stimuli selection based on user response predictions. As an option, one or more instances of touchpoint response predictive modeling technique 2A00 or any aspect thereof may be implemented in the context of the architecture and functionality of the embodiments described herein. Also, the touchpoint response predictive modeling technique 2A00 or any aspect thereof may be implemented in any desired environment.

FIG. 2A depicts process steps (e.g., touchpoint response predictive modeling technique 2A00) used in the generation of a touchpoint response predictive model (see grouping 247). As shown, stimulus data records 172 and response data records 174 associated with one or more historical marketing campaigns and/or time periods are received by a computing device and/or system (e.g., measurement server) over a network (see step 242). The information associated with the stimulus data records 172 and response data records 174 can be organized in various data structures. A portion of the collected stimulus and response data can be used to train a learning model (see step 244). A different portion of the collected stimulus and response data can be used to validate the learning model (see step 246). The processes of training and/or validating can be iterated (see path 248) until the learning model behaves within target tolerances (e.g., with respect to predictive statistic metrics, descriptive statistics, significance tests, etc.). In some cases, additional historical stimulus and response data can be collected to further and/or validate the learning model. When the learning model has been generated, a set of touchpoint response predictive model parameters 179 (e.g., input variables, output variables, equations, equation coefficients, mapping relationships, limits, constraints, etc.) describing the learning model can be stored in a measurement data store 264 for access by various computing devices (e.g., measurement server, management interface device, apportionment server, etc.).

Specifically, certain user interaction data (e.g., audience interactions 265) might be applied to the learning model to estimate the touchpoint lifts (see step 250) contributing to conversions, brand engagement events, and/or other events. The contribution value of a given touchpoint can then be determined (see step 252) for a given segment of users and/or media channel. For example, executing step 250 and step 252 might generate a chart showing the touchpoint contributions 266 for a given segment. Specifically, a percentage contribution for a touchpoint T4, a touchpoint T6, a touchpoint T7, and a touchpoint T8 can be determined for the segment (e.g., all users, male users, weekend users, California users, etc.). In some cases, the segment might represent a given marketing channel (e.g., display, search, TV, etc. and/or device platform (e.g., mobile, desktop, etc.). Further, the touchpoint contributions 266 can be used to determine a set of propensity scores associated with various combinations of user interactions (see step 254). For example, the shown set of propensity scores 268 might be generated to indicate the propensity to convert for a particular user (e.g., hypothetical user or real user) at any one of the stages (e.g., touchpoints T1, T6, T7, T4, T8, etc.) comprising the various interaction combinations.

Embodiments of certain data structures used by the touchpoint response predictive modeling technique 2A00 and/or other herein disclosed techniques are described in FIG. 213, FIG, 2C, and FIG. 2D.

FIG. 2B presents a touchpoint attribute chart 2B00 showing sample attributes associated with touchpoints of a marketing campaign. As an option, one or more instances of touchpoint attribute chart 2B00 or any aspect thereof may be implemented in the context of the architecture and functionality of the embodiments described herein. Also, the touchpoint attribute chart 2B00 or any aspect thereof may be implemented in any desired environment.

As discussed herein, a touchpoint can be any occurrence where a user interacts with any aspect of a marketing campaign (e.g., display ad, keyword search, TV ad, etc.). Recording the various stimulation and response touchpoints associated with a marketing campaign can enable certain key performance indicators (KPIs) for the campaign to be determined. For example, touchpoint information might be captured in the stimulus data records 172, the response data records 174, the observed touchpoint data records 176₁, the observed touchpoint data records 176₂, and/or user interaction data records 178 discussed in FIG. 1B, and/or other data records for use by the herein disclosed techniques. Yet, some touchpoints are more readily observed than other touchpoints. Specifically, touchpoints in non-digital media channels might be not be observable at a user level and/or an individual transaction level, such that summary and/or aggregate responses in non-digital channels are provided. In comparison, touchpoints in digital media channels can be captured real-time at a user level (e.g., using Internet technology). The attributes of such touchpoints in digital media channels can be structured as depicted in the touchpoint attribute chart 2B00.

Specifically, the touchpoint attribute chart 2B00 shows a plurality of touchpoints (e.g., touchpoint T4 204₁, touchpoint T6 206₁, touchpoint T7 207₁, touchpoint T8 208₁, touchpoint T5 205₁, and touchpoint T9 209₁) that might be collected and stored for various analyses (e.g., at a measurement server, an apportionment server, etc.). The example dataset of touchpoint attribute chart 2B00 maps the various touchpoints with a plurality of attributes 202 associated with respective touchpoints. For example, the attribute “Channel” identifies the type of channel (e.g., “Display”, “Search”) that delivers the touchpoint, the attribute “Message” identifies the type of message (e.g., “Brand”, “Call to Action”) delivered in the touchpoint, and so on, More specifically, as indicated by the “Event” attribute, touchpoint T4 204₁ was an “Impression” presented to the user, while touchpoint T6 206₁ corresponds to an item (e.g., “Call to Action” for “Digital SLR”) the user responded to with a “Click”. Also, as represented by the “Indicator” attribute, touchpoint T4 204₁ was presented (e.g., as indicated by a “1”) in the time window specified by the “Recency” attribute (e.g., “30+ Days”), while touchpoint T9 209₁ was not presented (e.g., as indicated by a “0”) in the time window specified by the “Recency” attribute (e.g., “<2 hours”). For example, the “Indicator” can be used to distinguish the touchpoints actually exposed to a user (e.g., comprising stimulus data records) as compared to planned touchpoint stimulus. In some cases, the “Indicator” can be used to identify responses to a given touchpoint (e.g., a “1” indicates the user responded with a click, download, etc.). Further, as indicated by the “User” attribute, touchpoint T4 204₁ was presented to a user identified as “UUID123”, while touchpoint T6 206₁ was presented to a user identified as “UUID456”. The remaining information in the touchpoint attribute chart 2B00 identifies other attribute values for the plurality of touchpoints.

A measurable relationship between one or more touchpoints and a progression through engagement and/or readiness states towards a target state is possible. In some cases, the relationship between touchpoints is deterministic (e.g., based on UUID). In other cases, the relationship between touchpoints can be probabilistic (e.g., a likelihood that two or more touchpoints are related). Such a collection of associated touchpoints can comprise a user interaction sequence. In some cases, such a collection of associated touchpoints can be called an engagement stack. Indeed, such user interaction sequences and/or engagements stacks can be applied to a touchpoint response predictive model to determine the contribution values of touchpoints associated with certain desired responses, such as conversion events, brand engagement events, and/or other events. As disclosed herein, such user interaction sequences can further be used in techniques for real-time marketing campaign stimuli selection based on user response predictions. One embodiment of a data structure for storing and/or accessing the observed touchpoint data comprising a collection of user interactions used in such techniques is illustrated in FIG. 2C.

FIG. 2C illustrates a touchpoint data record structure 2C00 used in systems for real-time marketing campaign stimuli selection based on user response predictions. As an option, one or more instances of touchpoint data record structure 2C00 or any aspect thereof may be implemented in the context of the architecture and functionality of the embodiments described herein. Also, the touchpoint data record structure 2C00 or any aspect thereof may be implemented in any desired environment.

The embodiment shown in FIG. 2C is one example of a data structure of the observed touchpoint data comprising the set of user interactions captured for use by the herein disclosed techniques. Specifically, the touchpoint data record structure 2C00 can represent the structure of a touchpoint experience of a certain user captured at a certain time. One or more sets of such touchpoint experiences can be associated (e.g., by user) and/or ordered (e.g., by time) to comprise one or more user interaction sequences (e.g., user interaction data 166). As shown, the touchpoint data record structure 2C00 can have a table structure comprising rows representing various touchpoint experiences and columns representing certain attributes associated with each touchpoint experience. For example, a touchpoint experience 212 might correspond to a certain touchpoint “4” experienced by user “UUID123” at “05/17/10 12:47 PM” and having attributes “A1_Value3”, “A2_Value5”, and “A3_Value2”. For example, the shown attributes might correspond to attributes such as those described in FIG. 2B. In some cases, the touchpoint experience might correspond to a conversion event (e.g., see Conversion column). As shown, a set of touchpoint experiences associated with a particular user (e.g., “UUID123”, “UUID456”, etc.) can be ordered by TimeStamp to indicate the touchpoints experienced by a given user as the user progresses towards conversion.

In some cases, online user interaction data not related to user stimuli, responses, and/or touchpoints can be used by the herein disclosed techniques. An example data structure for such online user interaction data is described in FIG. 2D.

FIG. 2D illustrates a user data record structure 2D00 used in systems for real-time marketing campaign stimuli selection based on user response predictions. As an option, one or more instances of user data record structure 2D00 or any aspect thereof may be implemented in the context of the architecture and functionality of the embodiments described herein. Also, the user data record structure 2D00 or any aspect thereof may be implemented in any desired environment.

The user data record structure 2D00 shown in FIG. 2D is an example structure for the user interaction data that can be used by the herein disclosed techniques for real-time marketing campaign stimuli selection based on user response predictions. Specifically, such user interaction data (e.g., user interaction data records 178) can be used to invoke the real-time stimuli selection process, to associate touchpoint experiences in user interaction sequences, and/or to facilitate other operations. In the shown example, log data 222 can comprise a user ID (e.g., UUID456) and a plurality of log lines (e.g., LOG LINE: . . . , etc.) associated with the user “UUID456”. Further, a log line, generated from online interactivity (e.g., browsing) can comprise various signals (e.g., IP address, timestamp, site, operating system or OS, cookie information, etc.) that can be used by the herein disclosed techniques. For example, a log line 224 received at “TimestampN” from a publisher associated with “SiteN” and/or “CookieN”, might invoke the selection of user stimuli to deliver in real time to user “UUID456”.

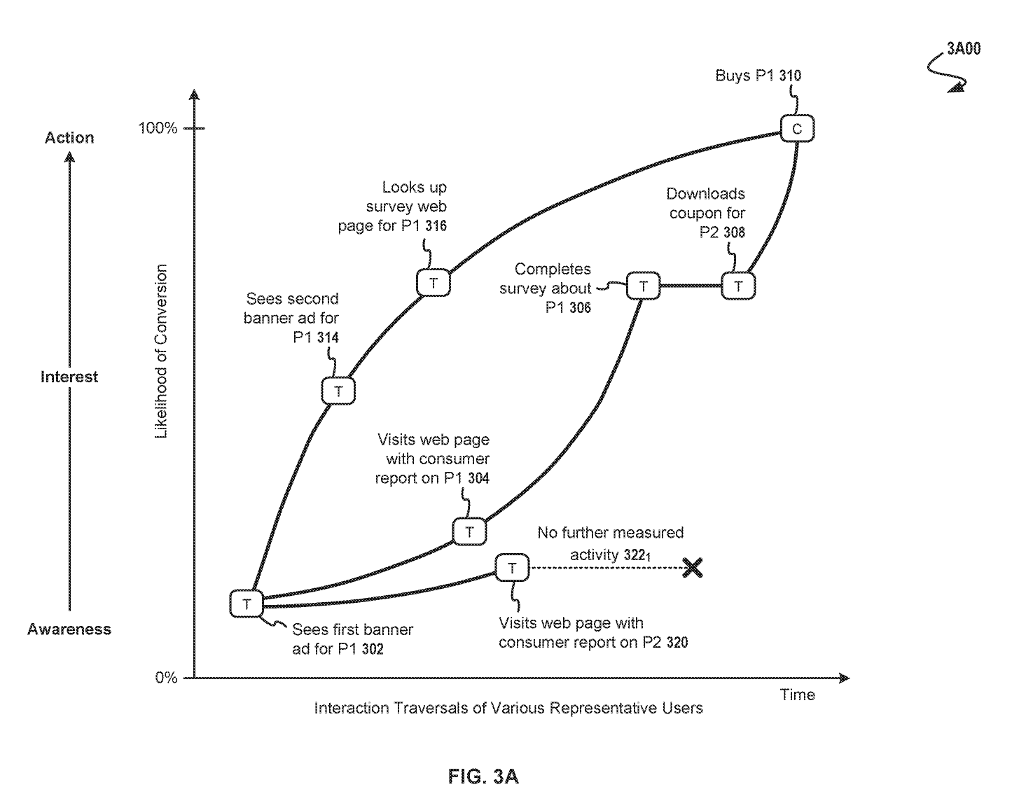

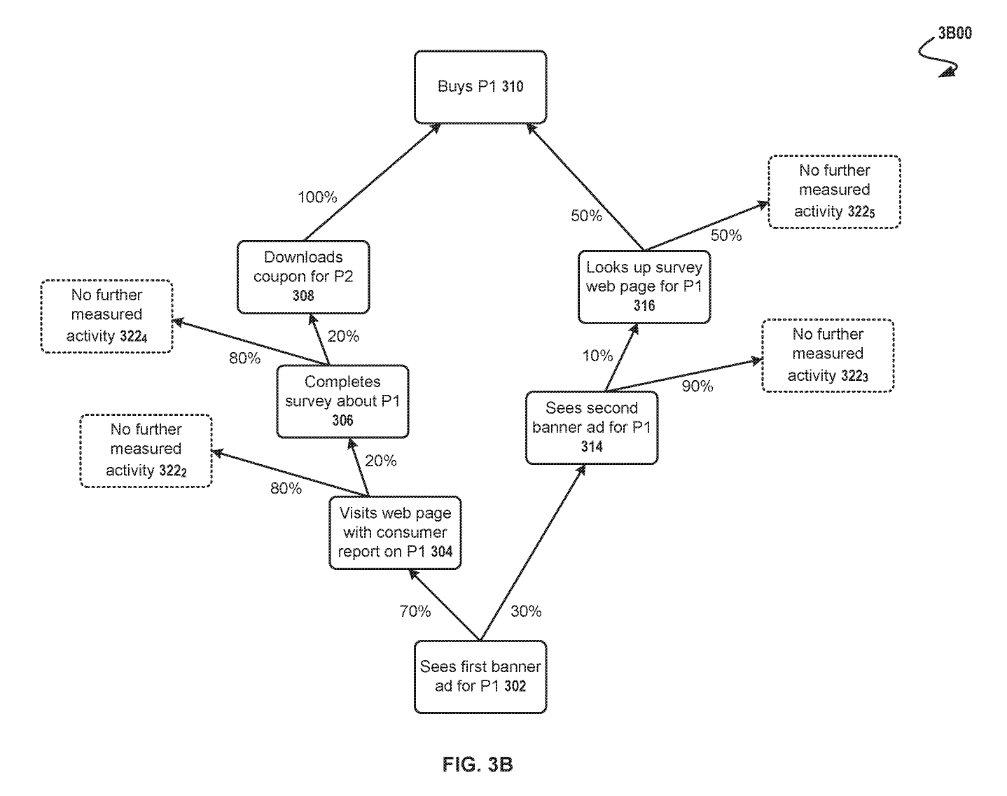

FIG. 3A is a user interaction sequence progression chart 3A00 depicting example user interaction sequences processed by systems for real-time marketing campaign stimuli selection based on user response predictions. As an option, one or more instances of user interaction sequence progression chart 3A00 or any aspect thereof may be implemented in the context of the architecture and functionality of the embodiments described herein. Also, the user interaction sequence progression chart 3A00 or any aspect thereof may be implemented in any desired environment.

The user interaction sequence progression chart 3A00 depicts the lift in a likelihood of conversion a user and/or group of users might incur from touchpoint experience to touchpoint experience in a sequence of online interactions. Specifically, the user interaction sequence progression chart 3A00 shows three interaction traversals that might be representative of an audience for particular marketing campaign. As shown, a first representative user sees a first banner ad for product P1 (see touchpoint 302). At a later moment in time, the same user visits a web page that has a consumer report on product P1 (see touchpoint 304). The likelihood of conversion is increased (e.g., lifted) by this event. Then the user completes a survey about product P1 (see touchpoint 306), and downloads a coupon for product P2 (see touchpoint 308), the former providing additional lift and the latter providing no additional lift from the user propensity level associated with the interaction with touchpoint 306. The user then makes a purchase of product P1 (see touchpoint 310). As further shown, a second representative user sees the first banner ad for product P1 (see touchpoint 302). At a later moment in time, the same user sees a second banner ad for product P1 (see touchpoint 314). The likelihood of conversion is increased (e.g., lifted) by this event. Then the user looks up a web survey for product P1 (see touchpoint 316). The user then makes a purchase of product P1 (see touchpoint 310).

In the foregoing examples, the representative users progress from awareness to interest, and to action. Each of the shown touchpoint experiences can be captured as data records and associated to form various collections of user interactions (e.g., user interaction sequences). Additional progressions can be observed, and different progressions may exhibit different lift from one interaction to another interaction. The reasons for lift (or lack thereof) between one interaction and another interaction might not be known or even postulated, yet, if a statistically large number of users are observed to have a progression that results in a conversion or other target event, then it can be statistically predicted that a particular user sharing the same characteristics and/or sharing the same experiences of sequencing through touchpoint interactions will convert with the same probability as the aforementioned statistically large number of users.

In some cases, a progression commences (e.g., two or more touchpoint interactions are measured), but the progression does not result in a statistically significant number of conversion observations. Specifically, as shown, a third representative user sees a first banner ad for product P1 (see touchpoint 302). At a later moment in time, the same user sees a consumer report for product P2 (see point 320). The likelihood of conversion is increased slightly (e.g., lifted) by this event, however, even after the passage of time, there is statistically no more activity observed for the representative user and/or group of users sharing certain characteristics who traversed through these two events (see message 322₁). In this case, a marketing manager might determine that the consumer report on P2 is hindering conversions, and might decide to take remedial action (e.g., to ‘take down’ or revise the offending consumer repo on product P2).

FIG. 3B is a user conversion propensity chart 3B00 depicting example user conversion propensity stages processed by systems for real-time marketing campaign stimuli selection based on user response predictions. As an option, one or more instances of user conversion propensity chart 3B00 or any aspect thereof may be implemented in the context of the architecture and functionality of the embodiments described herein. Also, the user conversion propensity chart 3B00 or any aspect thereof may be implemented in any desired environment.

The user conversion propensity chart 3B00 depicts the relative conversion propensity of users traversing through the touchpoint experiences described in FIG. 3A (e.g., touchpoint 302, touchpoint 304, touchpoint 306, touchpoint 308, touchpoint 310, touchpoint 314, and touchpoint 316). Specifically, as shown at the bottom of the user conversion propensity chart 3B00, a selected initial interaction event comprising seeing the first banner ad for P1 (see touchpoint 302) has two branches. In this example, 70% of the time, users later visit a web page with a consumer report on product P1 (see touchpoint 304), whereas 30% of the users progress to see a second banner ad for product P1 (see touchpoint 314). Each of those points (e.g., see touchpoint 304 and touchpoint 314) have respective traversals through other touchpoints. Such a chart or data structure representing such a chart can be derived from online touchpoint observations of a group of users, and the aggregate likelihood of conversion (e.g., propensity score) associated with various interactions from touchpoint 302 to the buy decision at touchpoint 310 can be determined. In this chart, and strictly as one example, the likelihood of conversion by a user at the moment of reaching the touchpoint 316 is 50%. However, the likelihood of conversion by a user at the moment of reaching the touchpoint 314 is only 5% (e.g., 50%*10%). At each touchpoint, there can further be a likelihood that there may be no further measured activity for a given (e.g., see message 322₂, message 322₃, message 322₄, and message 322₅).

A system implementing the herein disclosed techniques and/or a marketing manager might analyze empirically-determined data in the form of a chart such as user conversion propensity chart 3B00, and may reach conclusions as to events that precipitate other events. In some cases, certain stimulating events that are observed to precipitate other desirable events can be facilitated, which in turn can improve the performance of a media campaign. Specifically, if a stimulating event can be facilitated in the course of a media campaign, and the stimulating event can be determined to have a cause-effect relationship with one or more precipitating events, then the performance of a media campaign can be improved by facilitating the occurrence of such stimulating events.

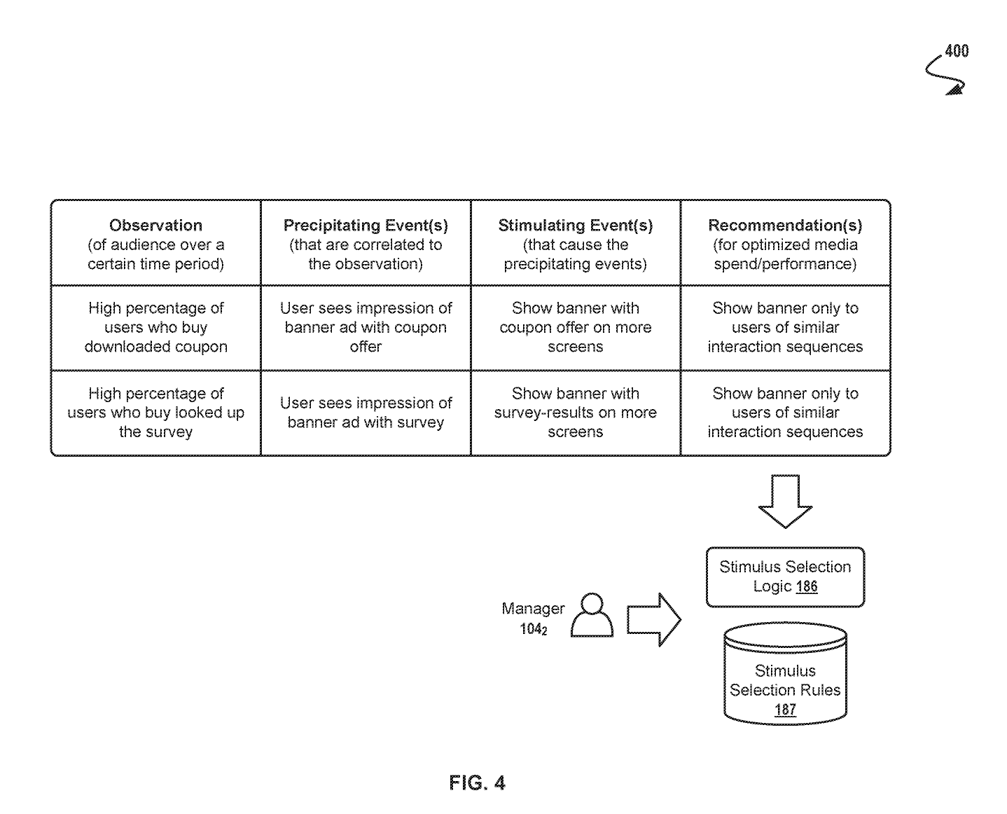

The alternatives available to a marketing manager to facilitate the occurrence and/or frequency of occurrence of stimulating events might be wide and varied, as shown in the following FIG. 4.

FIG. 4 depicts a logical flow 400 showing relationships among observations, events, and selection decision as implemented in systems for real-time marketing campaign stimuli selection based on user response predictions. As an option, one or more instances of logical flow 400 or any aspect thereof may be implemented in the context of the architecture and functionality of the embodiments described herein. Also, the logical flow 400 or any aspect thereof may be implemented in any desired environment.

The logical flow 400 depicts relationships between observations and events that are observed to precede desired conversion events. The logical flow 400 further shows relationships between the example precipitating events and the stimulating events. The rightmost column depicts a recommendation as to how to apportion media campaign spending in order to create stimulating events that cause the precipitating events, which precipitating events in turn cause or are correlated to desired behavior (e.g., a conversion or purchase decision). As shown, such recommendations might be implemented as a portion of the stimulus selection logic 186 and/or a portion of the stimulus selection rules 187. In some cases, a marketing manager (e.g., manager 104₂) can further manipulate the stimulus selection logic 186 and/or stimulus selection rules 187 according to particular marketing campaign characteristics (e.g., conversion targets, reach targets, etc.), media spend characteristics (e.g., total budget limits, etc.), and/or other criteria.

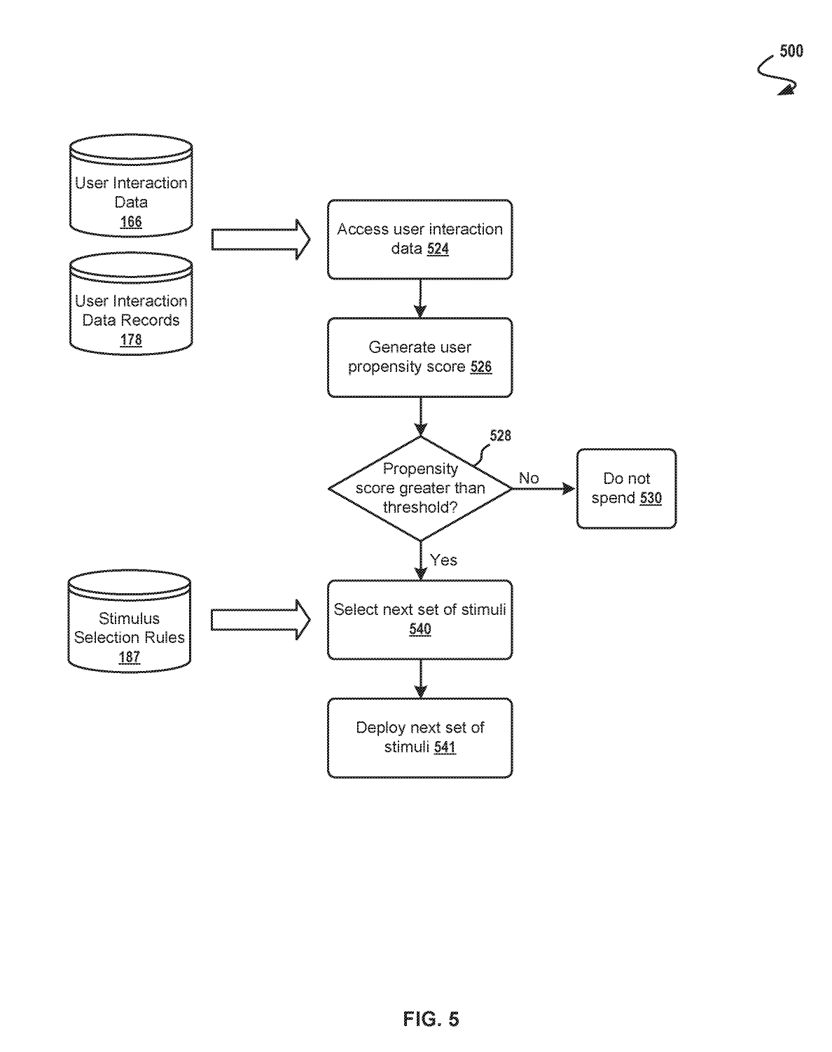

FIG. 5 presents a stimuli selection technique 500 used in systems for real-time marketing campaign stimuli selection based on user response predictions. As an option, one or more instances of stimuli selection technique 500 or any aspect thereof may be implemented in the context of the architecture and functionality of the embodiments described herein. Also, the stimuli selection technique 500 or any aspect thereof may be implemented in any desired environment.

There may be many touchpoints involved in the execution of a marketing campaign, and any one or more of the touchpoints may have made a calculable contribution to an empirically-determined conversion. In the stimuli selection technique 500, real-time marketing campaign stimuli selection is determined at least in part on the contribution of a particular set of one or more touchpoint interactions observed for a subject user with respect to other touchpoint interactions observed for a statistically large collection of users (e.g., online marketing campaign audience). Specifically, at the time a stimulus (e.g., advertisement, message, etc.) is to be presented to a particular user, a prediction regarding the likelihood of conversion of that user can be made based on the observed conversions of users with similar experiences and/or sequences of experiences over two or more touchpoints. If the likelihood of conversion is deemed to be high, a particular next set of stimuli can be selected based on the observed interactions leading to conversion. Strictly as one example, if the likelihood of conversion is deemed to be high, a message to incite action (e.g., a coupon) might be presented in lieu of a message to create awareness (e.g., a branding message).

More specifically, the stimuli selection technique 500 can access user interaction data (e.g., for users that have experienced at least some touchpoints) in order to determine observed interactions for one or more subject users (see step 524). For example, one or more instances of user interaction data records 178 (e.g., a log line for a subject user) might invoke the stimuli selection technique 500 to access one or more instances of the user interaction data 166 (e.g., data characterizing user interactions associated with the subject users) the time a stimulus is to be presented to the subject users. A user propensity score for each accessed set of user interactions can be generated based in part on the expected subject user responses to various combinations of selected stimuli based on the actual observed behaviors of a group of users having the same or similar touchpoint interaction experiences (see step 526). Such user propensity scores can represent a likelihood of conversion. In some embodiments, the user propensity score is calculated based upon predictions or estimations derived from a learning model (e.g., a touchpoint response predictive model), which in turn is based on a selection of empirically-determined conversions corresponding to specific sets and/or combinations of user interactions.

Further details related to formation and use of a propensity score are disclosed in U.S. patent application Ser. No. 14/465,838, entitled “APPORTIONING A MEDIA CAMPAIGN CONTRIBUTION TO A MEDIA CHANNEL IN THE PRESENCE OF AUDIENCE SATURATION” (Attorney Docket No. VISQ.P0021) filed on Aug. 22, 2014, the contents of which is hereby incorporated by reference in its entirety in the present application.

In some embodiments, certain users can be grouped into pools of users having similarly-scored collections of user interactions. In some cases, a user might be represented by cookie information associated with that user such that a group of similarly-scored collections of user interactions might have a corresponding group of similarly-scored cookies.

Further details related to formation of pools of similarly-scored cookies are disclosed in U.S. patent application Ser. No. 14/585,728, entitled “VALIDATION OF BOTTOM-UP ATTRIBUTIONS TO CHANNELS IN AN ADVERTISING CAMPAIGN” (Attorney Docket No. VISQ.P0011), filed on Dec. 30, 2014, which is hereby incorporated by reference in its entirety.

Continuing the discussion of the stimuli selection technique 500, when a representative portion of the accessed sets of user interactions have been scored, a calculation determines how many of the representative portion of the accessed sets of user interactions have a score above a given threshold (see decision 528). If there is a sufficiently high likelihood of conversion with further stimuli (e.g., propensity score is greater than a threshold), more spend might be allocated to further stimuli (see the “Yes” branch of decision 528). If the likelihood of conversion is low (e.g., propensity score is lower than a threshold), then no spend might be allocated to additional stimuli (e.g., see “No” branch of decision 528 and step 530).

In the event that there is a sufficiently high likelihood of conversion with further stimuli, a next stimulus and/or next set of stimuli can be selected for the subject users (see step 540). For example, the selected user stimuli might be identified based in part on the stimulus selection rules 187. Various techniques for deploying the selected user stimuli are possible (see step 541). For example, a set of parameters characterizing the selected user stimuli might be delivered to a demand side platform (e.g., DSP) to execute a buy of the selected user stimuli.

Strictly as an example, if a large percentage of online users are observed to have made purchase decisions after experiencing interactions with an advertisement in the form of a “creativeC”, followed by interactions with a “creativeB”, and if a subject user's interaction data show a recent experience with the “creativeC”, then certain steps of FIG. 5 (e.g., step 540 and step 541) might determine to present an impression of the “creativeB” to the subject user. In some cases, an ad server can present the foregoing impressions using a web server, in other cases an ad server can recommend the presentation of an impression. Specifically, in certain mobile environments, the ad server can recommend or queue a recommendation to the mobile device servers of any one or more campaign execution providers, which can in turn present the recommended creative in due course (e.g., when the subject user activates an app on a mobile device).

The ability to make an accurate prediction as to whether or not a user or group of similarly-scored users will convert can be implemented by a marketing analytics platform. Such predictions can be used for many purposes. For example, such predictions might be used in a display marketing campaign to choose to only show particular display ads to those users that have a propensity to convert when being exposed to those ads. Further, a marketing manager might recognize skew in apportionment to a particular touchpoint interaction sequence, and the frequency of certain touchpoints can be increased (or decreased). Such an increase (or decrease) may directly affect the spending amounts associated with the marketing campaign. In some cases, and in particular in situations as are described herein, touchpoint frequency can be determined based on the likelihood that increasing the touchpoint frequency will result in a desired response by the user. For example, if a user were known or predicted to have a progressively higher likelihood of taking some desired action (e.g., make a purchase decision) upon being shown a message being shown a coupon for 50% off), then the advertiser might want to increase the message frequency to that user. Conversely, if a user were known or predicted to have a progressively lower likelihood of taking some advertiser-desired action (e.g., the user already has a negative opinion of the brand) upon being shown a message, then the advertiser might want to decrease or completely eliminate touchpoint interaction (e.g., eliminate the message interaction) for that user. In the former case, increasing touchpoint frequency might require increased spending, the latter case, any allocated spending amount need not be depleted since that user is known or predicted to have a low likelihood of being motivated to some advertiser-desired action. Indeed, in some cases, a decision to spend or not to spend can be determined based on knowledge of certain user characteristics. Some possible decision-making flows are discussed hereunder.

### Additional Practical Application Examples

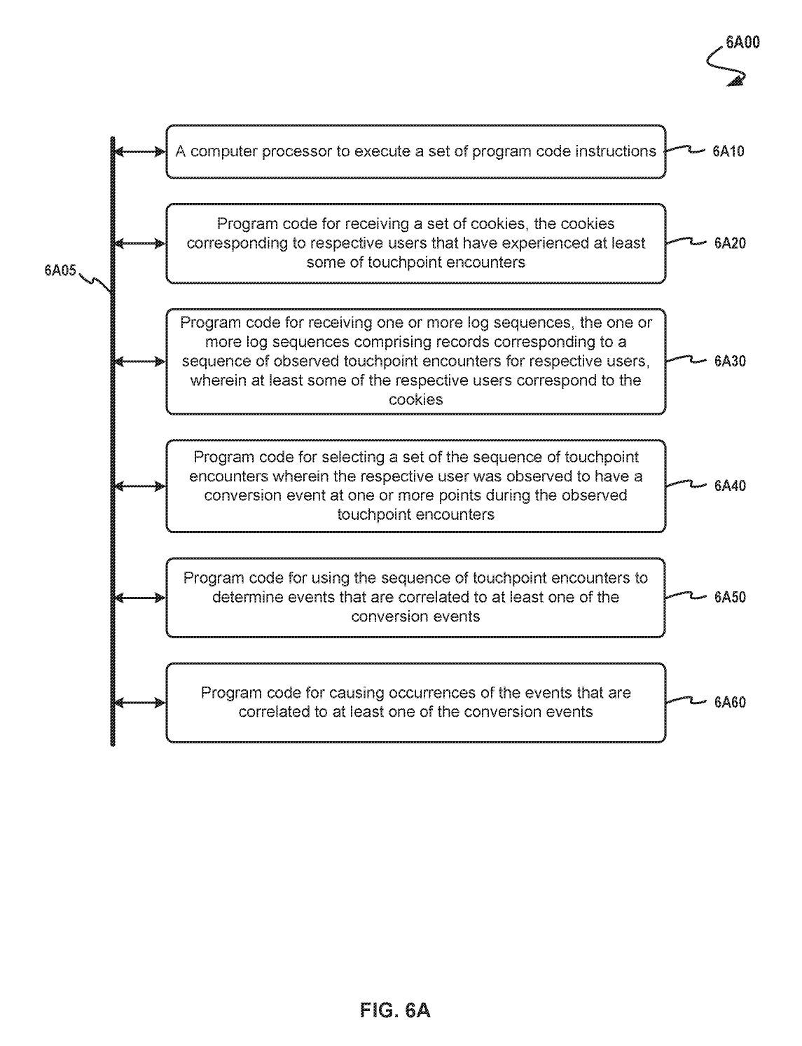

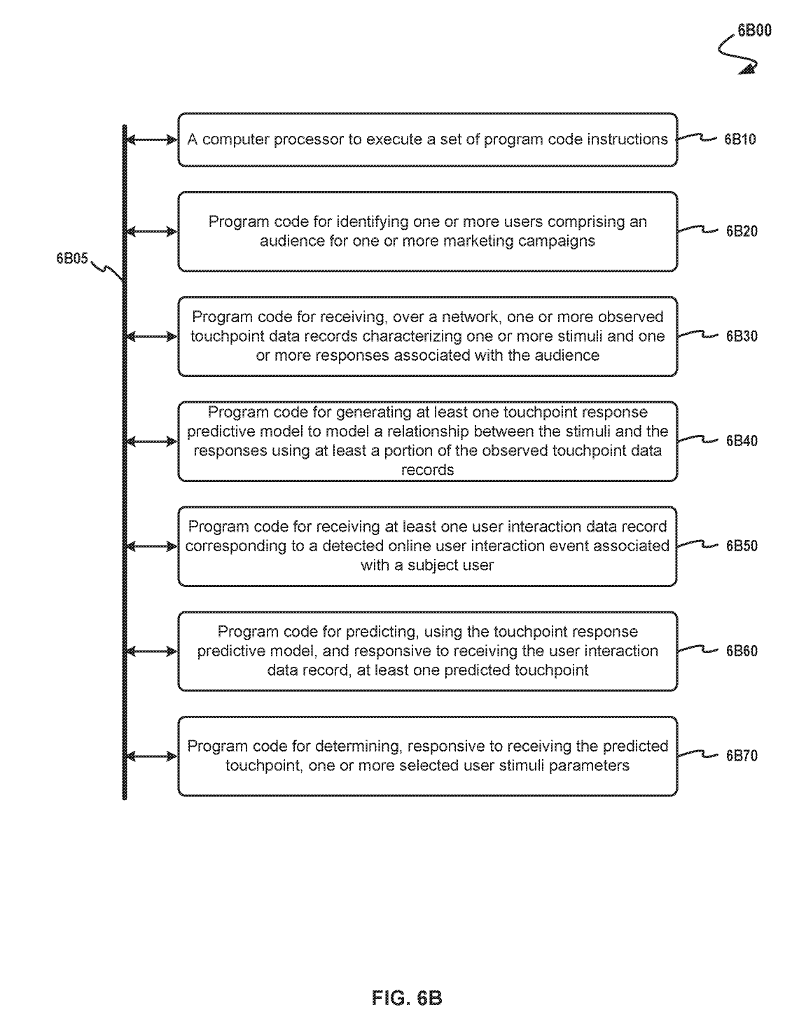

FIG. 6A is a block diagram of a system for using statistically accurate user behavior predictions to apportion campaign spending. As an option, the present system 6A00 may be implemented in the context of the architecture and functionality of the embodiments described herein. Of course, however, the system 6A00 or any operation therein may be carried out in any desired environment. The system 6A00 comprises at least one processor and at least one memory, the memory serving to store program instructions corresponding to the operations of the system. As shown, an operation can be implemented in whole or in part using program instructions accessible by a module. The modules are connected to a communication path 6A05, and any operation can communicate with other operations over communication path 6A05. The modules of the system can, individually or in combination, perform method operations within system 6A00. Any operations performed within system 6A00 may be performed in any order unless as may be specified in the claims. The shown embodiment implements a portion of a computer system, shown as system 6A00, comprising a computer processor to execute a set of program code instructions (see module 6A10) and modules for accessing memory to hold program code instructions to perform: receiving a data structure comprising set of cookies, the cookies corresponding to respective users that have experienced at least some of touchpoint encounters (see module 6A20); receiving one or more log sequences, the one or more log sequences comprising records corresponding to a sequence of observed touchpoint encounters for respective users, wherein at least some of the respective users correspond to the cookies (see module 6A30); selecting a set of the sequence of observed touchpoint encounters wherein the respective user was observed to have a conversion event at one or more points during the touchpoint encounters (see module 6A40); using the sequence of observed touchpoint encounters to determine at least one touchpoint event that is correlated to at least one of the conversion events (see module 6A50); and causing occurrences of the events that are correlated to at least one of the conversion events (see module 6A60). In some cases the act of causing occurrences is by adjusting a budget amount related to the touchpoint event. In other cases the act of causing occurrences includes emitting a recommendation to increase a frequency of occurrences of the touchpoint event.

FIG. 6B is a block diagram of a system for using statistically accurate user behavior predictions to apportion campaign spending. As an option, the present system 6B00 may be implemented in the context of the architecture and functionality of the embodiments described herein. Of course, however, the system 6B00 or any operation therein may be carried out in any desired environment. The system 6B00 comprises at least one processor and at least one memory, the memory serving to store program instructions corresponding to the operations of the system. As shown, an operation can be implemented in whole or in part using program instructions accessible by a module. The modules are connected to a communication path 6B05, and any operation can communicate with other operations over communication path 6B05. The modules of the system can, individually or in combination, perform method operations within system 6B00. Any operations performed within system 6B00 may be performed in any order unless as may be specified in the claims. The shown embodiment implements a portion of a computer system, presented as system 6B00, comprising a computer processor to execute a set of program code instructions (see module 6B10) and modules for accessing memory to hold program code instructions to perform: identifying one or more users comprising an audience for one or more marketing campaigns (see module 6B20); receiving, over a network, one or more observed touchpoint data records characterizing one or more stimuli and one or more responses associated with the audience (see module 6B30); generating at least one touchpoint response predictive model to model a relationship between the stimuli and the responses using at least a portion of the observed touchpoint data records (see module 6B40), receiving at least one user interaction data record corresponding to a detected online user interaction event associated with a subject user (see module 6B50); predicting, using the touchpoint response predictive model, and responsive to receiving the user interaction data record, at least one predicted touchpoint (see module 6B60); and determining, responsive to receiving the predicted touchpoint, one or more selected user stimuli parameters (see module 6B70).

Variations of the foregoing may include more or fewer of the foregoing modules and variations may perform more or fewer (or different) steps, and may use data elements in more or fewer (or different) operations. For example, a plurality of touchpoint encounters that represent marketing messages exposed to a plurality of users can be stored in any repository for subsequent retrieval to identify or map onto a particular segment of an audience. Such records can be segregated or sorted into separate sets of user data, for example (1) one set having converting user data that comprises touchpoint encounters for the users that exhibited a positive response to the marketing message, and (2) another set having non-converting user data that comprises touchpoint encounters for the users that did not exhibit a positive response to the marketing message. A predictive model is trained using training data derived from (1) the converting user data (and respective stimuli) as well as using training data derived from (2) the non-converting user data (and respective stimuli). Such a predictive model can be queried to return a plurality of sets of touchpoint encounters that reflect positive responses to respective stimuli. In another step, received user interaction data records that correspond to one or more online user touchpoint encounters (e.g., which interaction data records are associated with a user of the audience segment), the predictive model can be used for predicting effective stimuli. Presentation of the predicted effective stimuli serves to increase the likelihood of desired responses by the audience segment to the stimuli (e.g., in Internet marketing campaigns). A marketing manager can increase the frequency or reach of predicted effective stimuli, and/or the predicted effective stimuli (e.g., an impression) can be presented to a particular user upon that online user's touchpoint encounter with a touchpoint that is known to be correlated to the predicted effective stimuli.

### Additional System Architecture Examples

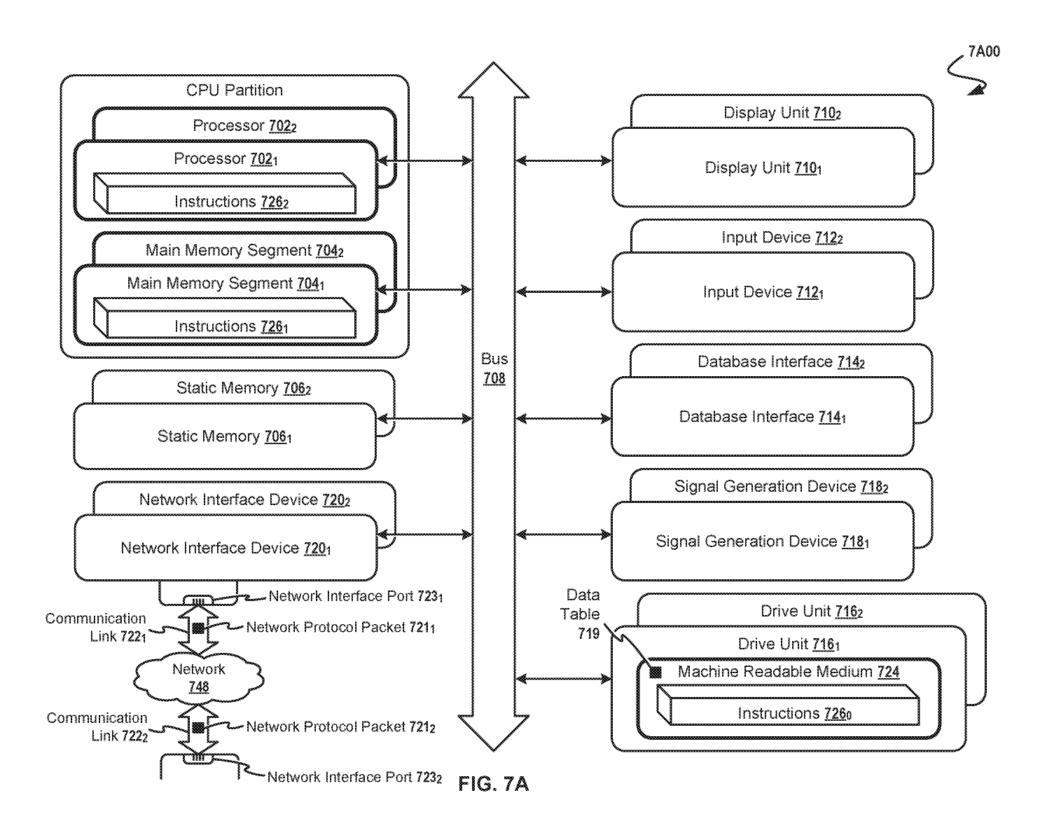

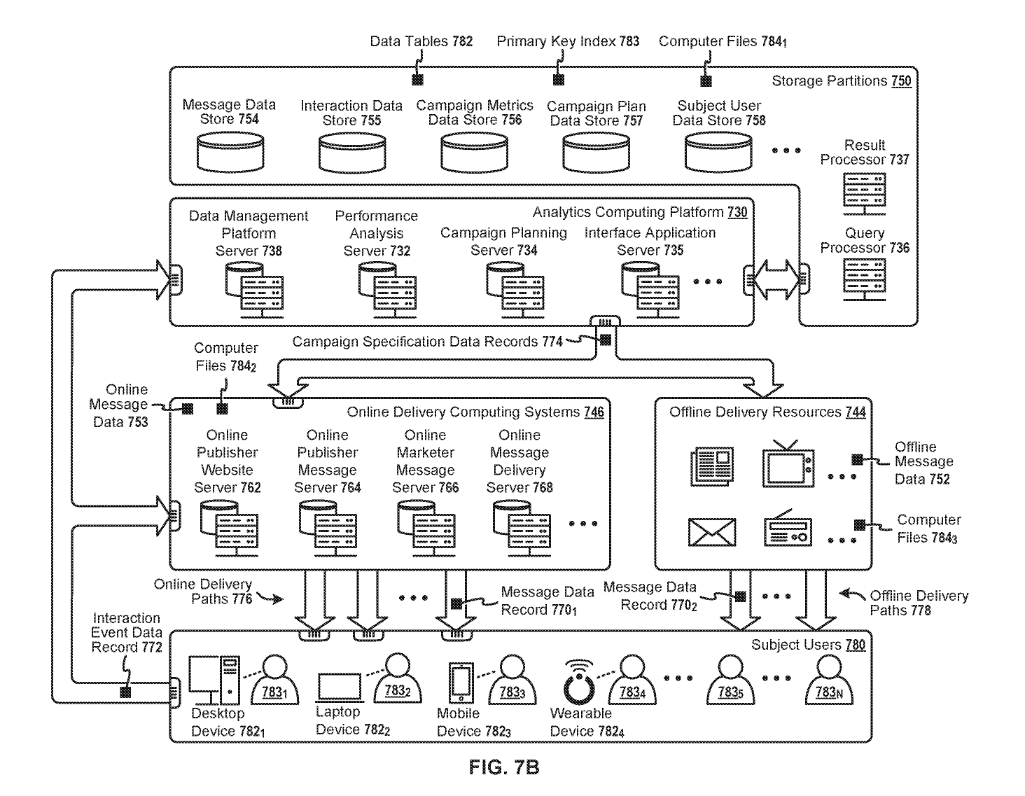

FIG. 7A depicts a diagrammatic representation of a machine in the exemplary form of a computer system 7A00 within which a set of instructions, for causing the machine to perform any one of the methodologies discussed above, may be executed. in alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 7A00 includes one or more processors (e.g., processor 702₁, processor 702₂, etc.), a main memory comprising one or more main memory segments (e.g., main memory segment 704₁, main memory segment 704₂, etc.), one or more static ones (e.g., static memory 706₁, static memory 706₂, etc.), which communicate with each other via a bus 708. The computer system 7A00 may further include one or more video display units display unit 710₁, display unit 710₂, etc.), such as an LED display, or a liquid crystal display (LCD), or a cathode ray tube (CRT). The computer system 7A00 can also include one or more input devices (e.g., input device 712₁, input device 712₂, alphanumeric input device, keyboard, pointing device, mouse, etc.), one or more database interfaces (e.g., database interface 714₁, database interface 714₂, etc.), one or more disk drive units (e.g., drive unit 716₁, drive unit 716₂, etc.), one or more signal generation devices (e.g., signal generation device 718₁, signal generation device 718₂, etc.), and one or more network interface devices (e.g., network interface device 720₁, network interface device 720₂, etc.).

The disk drive units can include one or more instances of a machine-readable medium 724 on which is stored one or more instances of a data table 719 to store electronic information records. The machine-readable medium 724 can further store a set of instructions 726₀ (e.g., software) embodying any one, or all, of the methodologies described above. A set of instructions 726₁ can also be stored within the main memory (e.g., in main memory segment 704₁). Further, a set of instructions 726₂ can also be stored within the one or more processors (e.g., processor 702₁). Such instructions and/or electronic information may further be transmitted or received via the network interface devices at one or more network interface ports (e.g., network interface port 723₁, network interface port 723₂, etc.). Specifically, the network interface devices can communicate electronic information across a network using one or more optical links, Ethernet links, wireline links, wireless links, and/or other electronic communication links (e.g., communication link 722₁, communication link 722₂, etc.). One or more network protocol packets (e.g., network protocol packet 721₁, network protocol packet 721₂, etc.) can be used to hold the electronic information (e.g., electronic data records) for transmission across an electronic communications network (e.g., network 748). In some embodiments, the network 748 may include, without limitation, the web (i.e., the Internet), one or more local area networks (LANs), one or more wide area networks (WANs), one or more wireless networks, and/or one or more cellular networks.

The computer system 7A00 can be used to implement a client system and/or a server system, and/or any portion of network infrastructure.

It is to be understood that various embodiments may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; or any other type of non-transitory media suitable for storing or transmitting information.

A module as used herein can be implemented using any mix of any portions of the system memory, and any extent of hard-wired circuitry including hard-wired circuitry embodied as one or more processors (e.g., processor 702₁, processor 702₂, etc.).

FIG. 7B depicts a block diagram of a data processing system suitable for implementing instances of the herein-disclosed embodiments. The data processing system may include many more or fewer components than those shown.

The components of the data processing system may communicate electronic information (e.g., electronic data records) across various instances and/or types of an electronic communications network (e.g., network 748) using one or more electronic communication links (e.g., communication link 722₁, communication link 722₂, etc.). Such communication links may further use supporting hardware, such as modems, bridges, routers, switches, wireless antennas and towers, and/or other supporting hardware. The various communication links transmit signals comprising data and commands (e.g., electronic data records) exchanged by the components of the data processing system, as well as any supporting hardware devices used to transmit the signals. In some embodiments, such signals are transmitted and received by the components at one or more network interface ports (e.g., network interface port 723₁, network interface port 723₂, etc.). In one or more embodiments, one or more network protocol packets (e.g., network protocol packet 721₁, network protocol packet 721₂, etc.) can be used to hold the electronic information comprising the signals.

As shown, the data processing system can be used by one or more advertisers to target a set of subject users 780 (e.g., user 783₁, user 783₂, user 783₃, user 783₄, user 783₅, to user 783_{N}) in various marketing campaigns. The data processing system can further be used to determine, by an analytics computing platform 730, various characteristics (e.g., performance metrics, etc.) of such marketing campaigns. Other operations, transactions, and/or activities associated with the data processing system are possible. Specifically, the subject users 780 can receive a plurality of online message data 753 transmitted through any of a plurality of online delivery paths 776 (e.g., online display, search, mobile ads, etc.) to various computing devices (e.g., desktop device 782₁, laptop device 782₂, mobile device 782₃, and wearable device 782₄). The subject users 780 can further receive a plurality of offline message data 752 presented through any of a plurality of offline delivery paths 778 (e.g., TV, radio, print, direct mail, etc). The online message data 753 and/or the offline message data 752 can be selected for delivery to the subject users 780 based in part on certain instances of campaign specification data records 774 (e.g., established by the advertisers and/or the analytics computing platform 730). For example, the campaign specification data records 774 might comprise settings, rules, taxonomies, and other information transmitted electronically to one or more instances of online delivery computing systems 746 and/or one or more instances of offline delivery resources 744. The online delivery computing systems 746 and/or the offline delivery resources 744 can receive and store such electronic information in the form of instances of computer files 784₂ and computer files 784₃, respectively. In one or more embodiments, the online delivery computing systems 746 can comprise computing resources such as an online publisher website server 762, an online publisher message server 764, an online marketer message server 766, an online message delivery server 768, and other computing resources. For example, the message data record 770₁ presented to the subject users 780 through the online delivery paths 776 can be transmitted through the communications links of the data processing system as instances of electronic data records using various protocols (e.g., HTTP, HTTPS, etc.) and structures (e.g., JSON), and rendered on the computing devices in various forms (e.g., digital picture, hyperlink, advertising tag, text message, email message, etc.). The message data record 770₂ presented to the subject users 780 through the offline delivery paths 778 can be transmitted as sensory signals in various forms (e.g., printed pictures and text, video, audio, etc.).

The analytics computing platform 730 can receive instances of an interaction event data record 772 comprising certain characteristics and attributes of the response of the subject users 780 to the message data record 770₁, the message data record 770₂, and/or other received messages. For example, the interaction event data record 772 can describe certain online actions taken by the users on the computing devices, such as visiting a certain URL, clicking a certain link, loading a web page that fires a certain advertising tag, completing an online purchase, and other actions. The interaction event data record 772 may also include information pertaining to certain offline actions taken by the users, such as purchasing a product in a retail store, using a printed coupon, dialing a toll-free number, and other actions. The interaction event data record 772 can be transmitted to the analytics computing platform 730 across the communications links as instances of electronic data records using various protocols and structures. The interaction event data record 772 can further comprise data (e.g., user identifier, computing device identifiers, timestamps, IP addresses, etc.) related to the users and/or the users' actions.

The interaction event data record 772 and other data generated and used by the analytics computing platform 730 can be stored on a storage device having one or more storage partitions 750 (e.g., message data store 754, interaction data store 755, campaign metrics data store 756, campaign plan data store 757, subject user data store 758, etc.). The storage partitions 750 can comprise one or more databases and/or other types of non-volatile storage facilities to store data in various formats and structures e.g., data tables 782, computer files 784₁, etc.). The data stored in the storage partitions 750 can be made accessible to the analytics computing platform 730 by a query processor 736 and a result processor 737, which can use various means for accessing and presenting the data, such as a primary key index 783 and/or other means. In one or more embodiments, the analytics computing platform 730 can comprise a performance analysis server 732 and a campaign planning server 734. Operations performed by the performance analysis server 732 and the campaign planning server 734 can vary widely by embodiment. As an example, the performance analysis server 732 can be used to analyze the messages presented to the users (e.g., message data record 770₁ and message data record 770₂) and the associated instances of the interaction event data record 772 to determine various performance metrics associated with a marketing campaign, which -tries can be stored in the campaign metrics data store 756 and/or used to generate various instances of the campaign specification data records 774. Further, for example, the campaign planning server 734 can be used to generate marketing campaign plans and associated marketing spend apportionments, which information can be stored in the campaign plan data store 757 and/or used to generate various instances of the campaign specification data records 774. Certain portions of the interaction event data record 772 might further be used by a data management platform server 738 in the analytics computing platform 730 to determine various user attributes (e.g., behaviors, intent, demographics, device usage, etc.), which attributes can be stored in the subject user data store 758 and/or used to generate various instances of the campaign specification data records 774. One or more instances of an interface application server 735 can execute various software applications that can manage and/or interact with the operations, transactions, data, and/or activities associated with the analytics computing platform 730. For example, a marketing manager might interface with the interface application server 735 to view the performance of a marketing campaign and/or to allocate media spend for another marketing campaign.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A computer implemented method comprising:
storing in a computer, a plurality of touchpoint encounters that represent marketing messages exposed to a plurality of users;
identifying an audience segment of users comprising a subset of the users;
sorting data for the touchpoint encounters in the computer to separate into converting user data, which comprises touchpoint encounters for the users that exhibited a positive response to the marketing message, and non-converting user data that comprises touchpoint encounters for the users that exhibited a negative response to the marketing message;
retrieving, from storage, the converting user data and the non-converting user data;
training, using machine-learning techniques in a computer, the converting user data and the non-converting user data as training data to generate a touchpoint response predictive model that defines a plurality of sets of touchpoint encounters that reflect a positive response to the marketing message;
receiving at least one user interaction data record corresponding to a detected online user touchpoint encounter associated with a user of the audience segment of users for presentation of one or more marketing campaigns;
predicting, using the touchpoint response predictive model, and responsive to the user interaction data record, at least one touchpoint encounter from a set of touchpoint encounters defined for the audience segment of users; and
determining one or more selected stimuli parameters for the user of the audience segment of users based on the predicted touchpoint to effectuate the marketing campaigns.

2. The computer implemented method of claim 1, further comprising generating a spending amount based at least in part on the selected user stimuli parameters.

3. The computer implemented method of claim 1, further comprising generating one or more user propensity scores that are based at least in part on the user interaction data record.

4. The computer implemented method of claim 3, wherein determining the user propensity scores is based at least in part on one or more predicted responses generated by applying a user interaction sequence to the touchpoint response predictive model.

5. The computer implemented method of claim 3, wherein determining the selected user stimuli parameters is further based on a difference between the user propensity scores and one or more thresholds.

6. The computer implemented method of claim 1, wherein the user interaction data record comprises cookie information associated with a particular subject user.

7. The computer implemented method of claim 6, wherein the selected user stimuli parameters characterize one or more touchpoints to be presented to the particular subject user.

8. The computer implemented method of claim 6, further comprising:
identifying one or more campaign execution providers to receive the selected user stimuli parameters for presenting a set of selected user stimuli to the particular subject user; and
delivering the selected user stimuli parameters to the campaign execution providers.

9. The computer implemented method of claim 1, further comprising:
providing a media planning application to at least one application user for operation on at least one management interface device; and
delivering the selected user stimuli parameters to the media planning application for presentation to the application user.

10. The computer implemented method of claim 1, further comprising: emitting a recommendation to increase a frequency of occurrences of stimuli corresponding to the detected online user touchpoint encounter.

11. A computer readable medium, embodied in a non-transitory computer readable medium, the non-transitory computer readable medium having stored thereon a sequence of instructions which, when stored in memory and executed by a processor causes the processor to perform a set of acts, the acts comprising:
storing in a computer, a plurality of touchpoint encounters that represent marketing messages exposed to a plurality of users;
identifying an audience segment of users comprising a subset of the users;
sorting data for the touchpoint encounters in the computer to separate into converting user data, which comprises touchpoint encounters for the users that exhibited a positive response to the marketing message, and non-converting user data that comprises touchpoint encounters for the users that exhibited a negative response to the marketing message;
retrieving, from storage, the converting user data and the non-converting user data;
training, using machine-learning techniques in a computer, the converting user data and the non-converting user data as training data to generate a touchpoint response predictive model that defines a plurality of sets of touchpoint encounters that reflect a positive response to the marketing message;
receiving at least one user interaction data record corresponding to a detected online user touchpoint encounter associated with a user of the audience segment of users for presentation of one or more marketing campaigns;
predicting, using the touchpoint response predictive model, and responsive to the user interaction data record, at least one touchpoint encounter from a set of touchpoint encounters defined for the audience segment of users; and
determining one or more selected stimuli parameters for the user of the audience segment of users based on the predicted touchpoint to effectuate the marketing campaigns.

12. The computer readable medium of claim 11, further comprising instructions which, when stored in memory and executed, causes the processor to perform generating a spending amount based at least in part on the selected user stimuli parameters.

13. The computer readable medium of claim 11, further comprising instructions which, when stored in memory and executed, causes the processor to perform generating one or more user propensity scores that are based at least in part on the user interaction data record.

14. The computer readable medium of claim 13, wherein determining the user propensity scores is based at least in part on one or more predicted responses generated by applying a user interaction sequence to the touchpoint response predictive model.

15. The computer readable medium of claim 13, wherein determining the selected user stimuli parameters is further based on a difference between the user propensity scores and one or more thresholds.

16. The computer readable medium of claim 11, wherein the user interaction data record comprises cookie information associated with a particular subject user.

17. The computer readable medium of claim 16, wherein the selected user stimuli parameters characterize one or more touchpoints to be presented to the particular subject user.

18. The computer readable medium of claim 11, further comprising instructions which, when stored in memory and executed, causes the processor to perform emitting a recommendation to increase a frequency of occurrences of stimuli corresponding to the detected online user touchpoint encounter. 19, A system comprising:
a storage device to store a plurality of touchpoint encounters that represent marketing messages exposed to a plurality of users; and
a processor for executing instructions which, when stored in a memory and executed by the processor causes the processor to perform,
identifying an audience segment of users comprising a subset of the users;
sorting data for the touchpoint encounters into separate into converting user data, which comprises touchpoint encounters for the users that exhibited a positive response to the marketing message, and non-converting user data that comprises touchpoint encounters for the users that exhibited a negative response to the marketing message;
retrieving, from the storage device, the converting user data and the non-converting user data;
training, using machine-learning techniques, the converting user data and the non-converting user data as training data to generate a touchpoint response predictive model that defines a plurality of sets of touchpoint encounters that reflect a positive response to the marketing message;
receiving at least one user interaction data record corresponding to a detected online user touchpoint encounter associated with a user of the audience segment of users for presentation of one or more marketing campaigns;
predicting, using the touchpoint response predictive model, and responsive to the user interaction data record, at least one touchpoint encounter from a set of touchpoint encounters defined for the audience segment of users; and
determining one or more selected stimuli parameters for the user of the audience segment of users based on the predicted touchpoint to effectuate the marketing campaigns.

20. The system of claim 19 wherein the user interaction data record comprises cookie information associated with a particular subject user.
